(19) United States
(12) Patent Application Publication
(10) Pub. No.: US 2016/0063519 A1
(43) Pub. Date: Mar. 3, 2016

(54) DATA ANALYSIS APPARATUS, DATA ANALYSIS SYSTEM, COMMODITY EXCHANGE FORECASTING APPARATUS, COMMODITY EXCHANGE FORECASTING SYSTEM, DATA ANALYSIS METHOD, COMMODITY EXCHANGE FORECASTING METHOD, AND COMPUTER-READABLE MEDIUM

(71) Applicant: NEC Corporation, Tokyo (JP)

(72) Inventor: Ruihan BAO, Tokyo (JP)

(73) Assignee: NEC Corporation

(21) Appl. No.: 14/836,008

(22) Filed: Aug. 26, 2015

(30) Foreign Application Priority Data
Aug. 27, 2014 (JP) 2014-172370

(51) Int. Cl. G06Q 30/02; G06T 7/00; G06T 1/00

(52) U.S. Cl. CPC G06Q 30/0201; G06Q 30/0202; G06T 1/0007; G06T 7/004; G06T 2207/10004

(57) ABSTRACT

A data analysis apparatus, system, method and non-transitory computer-readable storage medium are disclosed. A data analysis apparatus may include a memory storing instructions, and at least one processor configured to process the instructions to identify products included in a captured image, specify placement positions of the products, and analyze connection between a positional relation among the products and sales of the products based on the placement positions of the products and commodity exchange data of the products.

### CROSS-REFERENCE TO RELATED PATENT APPLICATIONS

This application is based upon and claims the benefit of priority from Japanese Patent Application No. 2014-172370, filed on Aug. 27, 2014. The entire disclosure of the above-referenced application is incorporated herein by reference.

### BACKGROUND

1. Field

The present disclosure may generally relate to a data analysis apparatus, a data analysis system, a commodity exchange forecasting apparatus, a commodity exchange forecasting system, a data analysis method, a commodity exchange forecasting method, and a computer-readable medium.

2. Description of the Related Art

Currently stores use POS (point-of-sale) systems to record commodity exchange data (e.g., sales data). POS systems may generate sales records including purchased items and sale prices with a timestamp. POS systems may enable a store to track inventory volume and revenue, when store clerks scan items at checkout. For example, a register may deduct items from a store inventory record when they are scanned and a sale is finalized. However, POS systems rely on human action to generate basic sales data. POS systems offer general data that are limited to providing information on straightforward trends.

### SUMMARY OF THE DISCLOSURE

Exemplary embodiments of the present disclosure may overcome disadvantages of prior systems. However, the present exemplary embodiments are not required to overcome specific disadvantages, and an exemplary embodiment of the present disclosure may provide other advantages.

According to an aspect of the present disclosure, an analysis apparatus is disclosed. The analysis apparatus may include a memory storing instructions, and at least one processor configured to process the instructions to identify products included in a captured digital image based on digitally processing the captured digital image, specify placement positions of the products, and analyze connection between a positional relation among the products and sales of the products based on the placement positions of the products and commodity exchange data of the products.

According to another aspect of the present disclosure, an analysis system is disclosed. The analysis system may include an imaging apparatus that captures an image of a shop rack, a POS (point-of-sale) system that manages commodity exchange data for a shop in which the shop rack is placed, and the data analysis apparatus described above, wherein the data analysis apparatus uses the image of the shop rack for identifying the products, and wherein the data analysis apparatus uses the commodity exchange data for analyzing the connection between the positional relation among the products and sales of the products based on the placement positions of the products and the commodity exchange data of the product.

According to another aspect of the present disclosure, an analysis method is disclosed. The analysis method may include identifying products included in a captured digital image based on digitally processing the captured digital image using at least one computer processor, specifying placement positions of the products, and analyzing connection between a positional relation among the products and sales of the products based on the placement positions of the products and commodity exchange data of the products.

According to another aspect of the present disclosure, a non-transitory computer-readable storage medium stores instructions that when executed by a computer enable the computer to implement a method is disclosed. The method may include identifying products included in a captured digital image based on digitally processing the captured digital image, specifying placement positions of the products, and analyzing connection between a positional relation among the products and sales of the products based on the placement positions of the products and commodity exchange data of the products.

### BRIEF DESCRIPTION OF THE DRAWINGS

FIG. 1 is a diagram illustrating an example of an overall configuration of a data analysis system according to at least one exemplary embodiment;

FIG. 2 is a functional block diagram illustrating an example of a functional configuration of a data analysis apparatus according to at least one exemplary embodiment;

FIG. 3 is a diagram for describing operation of an identification processor in the data analysis apparatus according to at least one exemplary embodiment;

FIG. 4 is a diagram for describing operation of an analysis processor in the data analysis apparatus according to at least one exemplary embodiment;

FIG. 5 is a diagram for describing operation of the analysis processor in the data analysis apparatus according to at least one exemplary embodiment;

FIG. 6 is a diagram for describing operation of an analysis processor in a data analysis apparatus according to at least one exemplary embodiment;

FIG. 7 is a diagram for describing operation of the analysis processor in the data analysis apparatus according to at least one exemplary embodiment;

FIG. 8 is a functional block diagram illustrating an example of a functional configuration of a data analysis apparatus according to at least one exemplary embodiment;

FIG. 9 is a diagram for describing operation of an analysis processor in the data analysis apparatus according to at least one exemplary embodiment;

FIG. 10 is a diagram for describing operation of the analysis processor in the data analysis apparatus according to at least one exemplary embodiment;

FIG. 11 is a diagram for describing operation of an analysis processor in a data analysis apparatus according to at least one exemplary embodiment;

FIG. 12 is a diagram for describing operation of an analysis processor in a data analysis apparatus according to at least one exemplary embodiment;

FIG. 13 is a diagram for describing operation of an analysis processor in a data analysis apparatus according to at least one exemplary embodiment;

FIG. 14 is a diagram for describing operation of an analysis processor in a data analysis apparatus according to at least one exemplary embodiment;

FIG. 15 is a diagram for describing operation of an analysis processor in a data analysis apparatus according to at least one exemplary embodiment;

FIG. 16 is a diagram for describing operation of an analysis processor in a data analysis apparatus according to at least one exemplary embodiment;

FIG. 17 is a diagram for describing operation of the analysis processor in the data analysis apparatus according to at least one exemplary embodiment;

FIG. 18 is a diagram illustrating an example of respective elements of a feature vector used by an analysis processor in a data analysis apparatus according to seventh least one exemplary embodiment;

FIG. 19 is a diagram illustrating an example of a result of analysis by the analysis processor in the data analysis apparatus according to at least one exemplary embodiment;

FIG. 20 is a functional block diagram illustrating an example of a functional configuration of a data analysis apparatus according to at least one exemplary embodiment;

FIG. 21 is a diagram illustrating an example of an overall configuration of a sales forecasting system according to at least one exemplary embodiment;

FIG. 22 is a functional block diagram illustrating an example of a functional configuration of a sales forecasting apparatus according to at least one exemplary embodiment;

FIG. 23 is a diagram for describing operation of a forecasting processor in the sales forecasting apparatus according to at least one exemplary embodiment;

FIG. 24 is a diagram illustrating an example of sales forecasting data used for sales forecasting by the forecasting processor in the sales forecasting apparatus according to at least one exemplary embodiment;

FIG. 25 is a diagram illustrating an example of a functional configuration of a sales forecasting apparatus according to at least one exemplary embodiment; and

FIG. 26 is a diagram illustrating an exemplary hardware configuration of a computer (information processing apparatus) that can provide each exemplary embodiment.

### DETAILED DESCRIPTION

In the following detailed description numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawings.

Disclosed embodiments provide techniques that check the layout of products using an image captured of the products. Disclosed embodiments may use captured images to determine information on layout positions and sales of products. These techniques may allow disclosed system to evaluate causal connections between the sales of products and a positional relation among the products in the entire shop.

### First Example

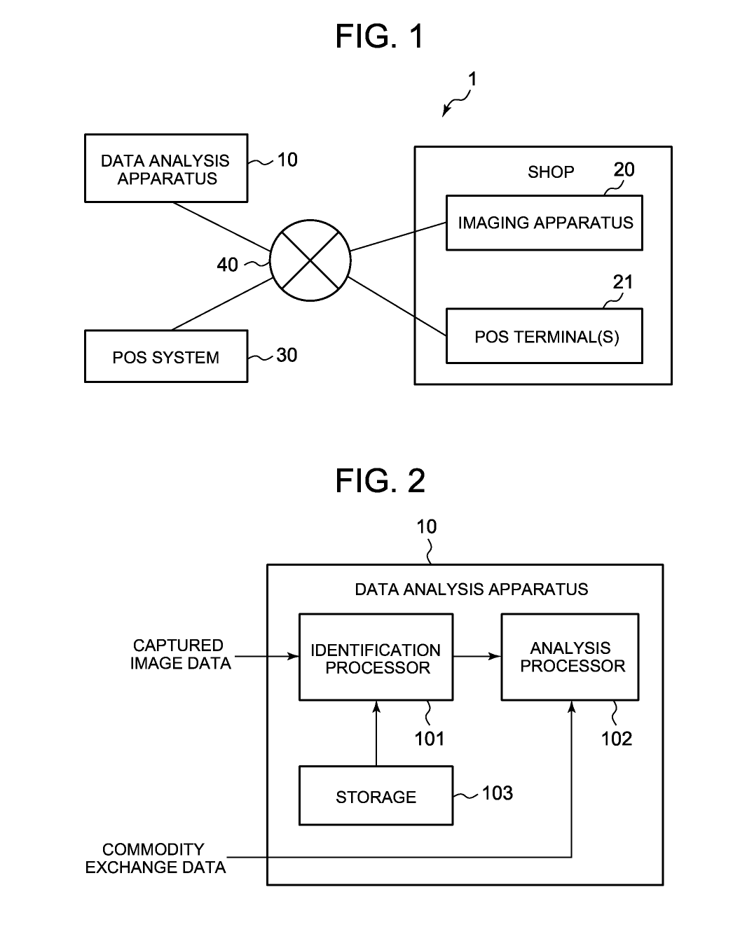

A first example of the present disclosure will be described in detail with reference to the drawings. An overall configuration of a data analysis system including a data analysis apparatus according to the present example will be described with reference to FIG. 1.

FIG. 1 is a diagram illustrating an example of an overall configuration of a data analysis system according to at least one exemplary embodiment. As illustrated in FIG. 1, a data analysis system 1 may include a data analysis apparatus 10, an imaging apparatus 20, POS (point-of-sale) terminal(s) 21 and a POS system 30. The data analysis apparatus 10, the imaging apparatus 20, the POS terminal 21 and the POS system 30 may be mutually connected via a network 40. The data analysis system 1 illustrated in FIG. 1 may be one indicating a configuration particular to the present disclosure, and the data analysis system 1 illustrated in FIG. 1 may include members not illustrated in FIG. 1.

The imaging apparatus 20 may be provided by, e.g., one or more monitoring cameras installed in each of one or more shops. In FIG. 1, one shop is illustrated. The number of shops may be no less than one. The imaging apparatus 20 may not be limited to monitoring cameras, and may be a portable one that can be carried by a user.

In the shop, plural shop racks (also simply referred to “rack(s)”) on which products are placed (laid out) may be installed. The imaging apparatus 20 may capture images of the shop racks. The imaging apparatus 20 may transmit captured image data (also simply referred to as “image data”) indicating each captured image to the data analysis apparatus 10. The captured image data may contain information indicating a shop rack captured in the captured image (shop rack information) and information indicating a time when the image was captured. For example, the shop rack information may include information indicating a shop in which the shop rack is installed and information indicating a position of the shop rack. In some instances, the shop rack information may not be limited to this example. For example, the shop rack information may include information indicating the imaging apparatus 20 and information indicating a direction of the imaging apparatus 20 or information indicating a position of the imaging apparatus 20, which is measured using, for example, a GPS (global positioning system) or the like. The shop rack information may include information that enables determination of which of shop rack in which shop the image was captured of.

The POS system 30 may communicate with one or more POS terminals 21 installed in each shop, and receive, from the POS terminal(s) 21, sales information indicating, for example, product name-based sales in the shop where the POS terminal(s) is 21 installed. The POS system 30 may be a system that manages the received sales information on a product name-by-product name basis and on a shop-by-shop basis. Sales information may refer to general POS data such as, for example, a sales amount or a sales volume of a certain product. In some instances, is the sales information may not be limited to these examples. The sales information sent from the POS terminal(s) 21 to the POS system 30 may include, for example, information such as a type of the product and/or genders of purchasers of the product. The sales information may include POS data with ID (identifier) including, e.g., purchaser information. Hereinafter, sales information managed by the POS system 30 may be referred to as commodity exchange data.

FIG. 1 indicates that the POS system 30 is provided separately from the shop with the POS terminal(s) 21 installed therein. In some instances, the configuration of the POS system 30 may not be limited to this case. The POS system 30 may be provided for each shop. The POS system 30 may be one integrated with the POS terminal(s) 21.

The POS system 30 may transmit the commodity exchange data the POS system 30 manages to the data analysis apparatus 10.

The data analysis apparatus 10 may receive the captured image data from the imaging apparatus 20. The data analysis apparatus 10 may receive the commodity exchange data from the POS system 30. The data analysis apparatus 10 may perform data analysis using the received captured image data and commodity exchange data. In some aspects, in the data analysis apparatus 10, a date and a time indicated by the commodity exchange data and a date and a time included in the captured image data provided by the imaging apparatus 20 may fall within a predetermined range. In some instances, the data analysis apparatus 10 may perform data analysis using data of an image captured during a period of time from, e.g., previous replacement of products to next replacement, and commodity exchange data for that period. The timing for the data analysis apparatus 10 to perform data analysis may not be specifically limited. Detailed functions of the data analysis apparatus 10 will be described with reference to FIG. 2.

### (Data Analysis Apparatus 10)

FIG. 2 is a functional block diagram illustrating an example of a functional configuration of the data analysis apparatus 10 in the data analysis system 1 according to at least one exemplary embodiment. As illustrated in FIG. 2, the data analysis apparatus 10 may include an identification processor 101, an analysis processor 102 and a storage 103. Data analysis apparatus 10 may also include memory (not shown) storing instructions executable by one or more processors to carry out the disclosed operations.

The storage 103 may store at least product images of respective products placed currently in shop racks in the shops. The storage 103 may store product images of products placed in the past in the shop racks in any of the shops and/or product images of products that may possibly be placed in the future in shop racks in any of the shops. A frequency of update of the product images may not be specifically limited, and examples of timings for the update may include, e.g., a timing of releasing a new product, and a timing of renewing of a package of a product.

The storage 103 may be incorporated in the data analysis apparatus 10 or may be provided by a storage apparatus that is separated from the data analysis apparatus 10. The storage 103 may be included in the identification processor 101.

The identification processor 101 may receive captured image data transmitted by the imaging apparatus 20. The identification processor 101 may identify products included in a captured image represented by the captured image data, by processing the image using the product images stored in the storage 103. The identification processor 101 may cut out a sub-region including a product image from the captured image and identify a product included in the captured image using plural feature amounts extracted from the cut-out sub-region. The identification processor 101 may identify a product included in the captured image using plural feature amounts extracted from the captured image, without cutting out a sub-region including a product image from the captured image.

Consequently, even if products overlap each other, the products can be identified with good precision. Since the identification processor 101 can simultaneously identify multiple products from a captured image, the identification processor 101 may be also referred to as a simultaneous multiple identification system.

The identification processor 101 may specify positions at which the identified products are placed. The placement positions of the products may be required to be ones indicating positions at which the products are placed in the shop rack. For example, the placement positions of the products may be expressed by coordinates in the captured image. When the placement positions of the products are expressed by coordinates in the captured image, each of the placement positions may be expressed by coordinates of tips (for example, coordinates of each of four corners in the case of a quadrilateral product) or a center of gravity. Hereinafter, information indicating a position in a shop rack specified by the identification processor 101 (rack position) may be referred to as rack position information.

The identification processor 101 may generate output data associating (including) product information indicating the identified products and rack position information indicating the specified placement positions of the products, and supply the output data to the analysis processor 102 as an identification result.

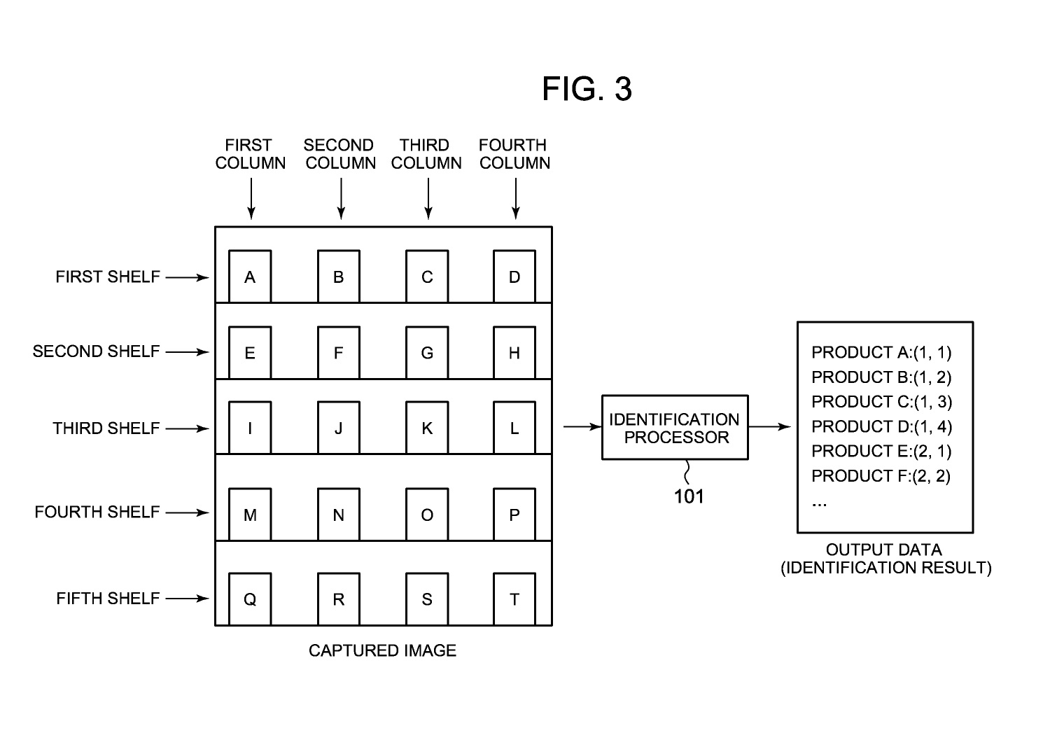

Operation of the identification processor 101 will be described with reference to FIG. 3. FIG. 3 is a diagram for describing operation of the identification processor 101. In FIG. 3, the figure positioned on the left of the block of the identification processor 101 is the figure illustrating an example of a captured image represented by the captured image data received by the identification processor 101 from the imaging apparatus 20. In FIG. 3, the figure positioned on the right of the block of the identification processor 101 is the figure illustrating an example of the output data (identification result) generated by the identification processor 101.

As illustrated in the left side of FIG. 3, the captured image may include plural products (A to T) placed in a shop rack having plural shelves (in FIG. 3, a five-shelf shop rack). The alphabetical letters included in the captured image in FIG. 3 may indicate a certain part of product names of the products. In other words, in FIG. 3, “A” may indicate a product whose product name is “Product A”. The number of shelves, the number of columns of products placed and the numbers of the products illustrated in FIG. 3 are examples, and they may not be limited to these examples. In the present exemplary embodiment, shelves of a shop rack may also be referred to as rows.

The identification processor 101 may identify each of the plurality of products (A to T). The identification processor 101 may specify rack positions of the products on a product-by-product basis. In FIG. 3, in the five-shelf shop rack, an uppermost shelf is referred to as a first shelf, followed by a second shelf, a third shelf, . . . in descending order. In FIG. 3, placement positions of products in a certain rack are referred to as a first column, a second column, . . . in this order from the left. The identification processor 101 may specify, for example, the rack position of “A” as the first column of the first shelf. As described above, a placement position of a product specified by the identification processor 101 may be expressed by coordinates in a captured image.

In FIG. 3, the numbers of products placed in the respective shelves are all the same. In some instances, the numbers of products placed in the respective shelves may not be limited to this case. The count of products placed on each shelf may differ depending on the shelf.

The identification processor 101 may generate output data associating product information indicating identified products and rack position information indicating specified placement positions of the products with each other. An example of the generation of the output data will be described.

In the present exemplary embodiment, rack position information indicating a rack position of a product on an x-th shelf and a y-th column (x and y are arbitrary natural numbers) may be indicated by (x, y). For example, rack position information for “A” is (1, 1). The identification processor 101 may associate product information indicating “A” (product name “Product A” in this example) and (1, 1), which is rack position information for the “A”, with each other. Product information may be required to be information for identifying a product. For example, product information may be a product name of a product as described above or may be an identifier for identifying a product. The identification processor 101 may perform processing that is similar to the above on other products included in the captured image.

Where “Product A” is simply indicated, the “Product A” may indicate a product whose product name is Product A.

The identification processor 101 may generate output data associating product information and rack position information with each other. As illustrated in FIG. 3, the identification processor 101 may associate product information for products and rack position information for the products with each other using colons (:). The identification processor 101 may output output data associating the product information and the rack position information with each other as an identification result. Information associated with product information (in FIG. 3, rack position information) may also be referred to as an element associated with product information. For description, colons (:) are used to associate product information for products and rack position information for the products with each other. In some instances, as long as association can be generated, the format of the association may not be specifically limited to this case.

### (Analysis Processor 102)

Functions of the analysis processor 102 will be described. As illustrated in FIG. 1, the analysis processor 102 may receive the output data (identification result) output by the identification processor 101, from the identification processor 101. The analysis processor 102 may receive the commodity exchange data transmitted by the POS system 30. The analysis processor 102 may analyze a relation between placement positions of products and sales of the products using the identification result and the commodity exchange data.

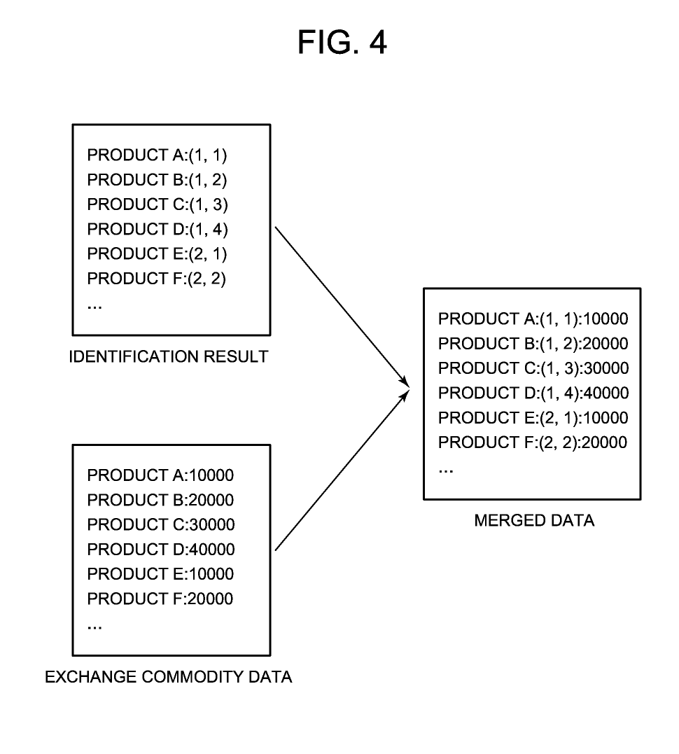

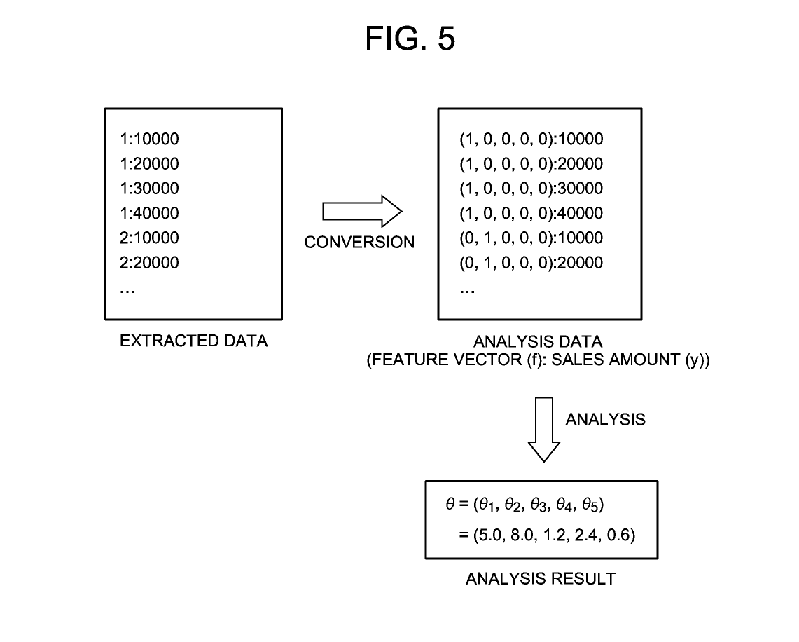

Operation of the analysis processor 102 will be described with reference to FIGS. 4 and 5. Each of FIGS. 4 and 5 is a diagram for describing operation of the analysis processor 102. In FIG. 4, the figure positioned on the upper left side may indicate the output data (identification result) output by the identification processor 101 and received by the analysis processor 102 from the identification processor 101. The identification result may be similar to that of FIG. 3. In FIG. 4, the figure positioned on the lower left side may be the figure illustrating an example of the commodity exchange data received by the analysis processor 102 from the POS system 30. In FIG. 4, the figure positioned on the right side may be the figure illustrating an example of data resulting from the identification result and the commodity exchange data being merged (referred to as merged data).

In the example illustrated in FIG. 4, the commodity exchange data transmitted from the POS system 30 may be information indicating product names as product information and sales amounts of the products as sales information for the products. Information included in the commodity exchange data may not be limited to that of this example. For example, the product information may include identifiers for identifying the products. The sales information may include sales volumes. The commodity exchange data may include other information.

The analysis processor 102 may determine whether or not the product names in the identification result and the product names in the commodity exchange data correspond to each other. If the product names correspond to each other, the analysis processor 102 may generate merged data associating (1) the product names, (2) the elements associated with the product names in the identification result and (3) the elements associated with the product names in the commodity exchange data with one another. In other words, in the present exemplary embodiment, the analysis processor 102 may generate merged data associating (1) the product names, (2) rack position information for the products indicated by the product names and (3) the sales amounts of the products indicated by the product names with one another. For example, rack position information for a product whose product name is “Product A” may be (1, 1) as indicated in the identification result, and the sales amount of the product may be “10000” as indicated in the commodity exchange data. The analysis processor 102 may merge these to generate merged data “Product A: (1, 1): 10000”. As described above, the analysis processor 102 may associate elements associated with a certain product name, with each other.

In the above example, as an example of product information used for associating elements included in identification result and elements included in the commodity exchange data, product names are used. In some instances, the product information used for associating elements included in identification result and elements included in the commodity exchange data may not be limited to this example. For example, where product information included in identification result includes identifiers for identifying products (product identifiers) and product information included in the commodity exchange data includes product names, the analysis processor 102 may obtain product identifiers associated with the product names from, for example, the storage 103. The analysis processor 102 may merge the identification result and the commodity exchange data using the product identifiers. The order of merging in the merged data may not be limited to that of this example, and may be required to be one indicating that the product names, the shelves of the rack and sales amounts are associated with one another, respectively.

The analysis processor 102 may extract information for analysis from the merged data. In the present exemplary embodiment, as information for analysis, the shelves of the rack in the rack position information for the products, and the sales amounts may be used.

In the present exemplary embodiment, as information for analysis, the shelves of the rack in the rack position information for the products and the sales amounts of the products may be used. In some aspects, as illustrated in FIG. 5, the extracted data may be one resulting from the shelves of the rack and the sales amounts being extracted from the merged data. In the merged data, the rack position information including the shelves of the rack, and the sales amounts may be associated with each other, and, the shelves of the rack and the sales amounts included in the extracted data may be associated with each other. In FIG. 5, this association is expressed using colons (:).

The analysis processor 102 may convert the extracted data with the shelves of the rack and the sales amounts associated with each other into analysis data, which is data that can be subjected to data analysis. In the present exemplary embodiment, the analysis data may be expressed using feature vectors. In some instances, the shelves of the rack may be expressed using a feature vector f. A feature vector f may be expressed by Expression (1) below.

[Expression 1]

f̅=(f₁,f₂,f₃,f₄,f₅) (1)

A feature vector f may include components. The number of components included in the feature vector f may correspond to the number of shelves of the rack, and the subscript x to each component fₓ may indicate what number shelf of the rack the relevant shelf is. In other words, f₁ may indicate the first shelf of the rack. It is assumed that the sales amount of the relevant product corresponding to the feature vector f is y. The value of each component may indicate whether or not the relevant product is placed. In some instances, the value of each component may indicate 1 if the product is placed on the relevant shelf, and indicate 0 if the product is not placed on the shelf. In some aspects, the analysis data including the feature vectors (f) and the sales amounts (y) may be data such as illustrated in FIG. 5. In some instances, “1:10000” on the first row of the extracted data may indicate that the sales of a product placed on the first shelf of the rack (Product A where FIG. 4 is referred to) is 10000, and thus, analysis data for this product may be “(1, 0, 0, 0, 0):10000” as illustrated in FIG. 5.

The present exemplary embodiment has been described in terms of a case where the analysis processor 102 converts the shelves of the rack into feature vectors after generating merged data. In some instances, the process of the analysis processor 102 may not be limited to this case. The analysis processor 102 may, for example, convert each product to the feature vector indicated in Expression (1) using the identification result, and generate merged data using product names associated with the feature vectors and the product names in the commodity exchange data. The analysis processor 102 may generate the analysis data illustrated in FIG. 5 by extracting the feature vectors and the sales amounts from the merged data. In other words, the analysis processor 102 in the data analysis apparatus 10 according to the present exemplary embodiment may be required to generate analysis data that can be subjected to data analysis, using the identification result and the commodity exchange data, and a procedure for the analysis data generation may not be specifically limited.

The analysis processor 102 may perform data analysis using the analysis data. The present exemplary embodiment will be described in terms of a case where the analysis processor 102 performs data analysis using a least-squares method. In some instances, the analysis processor 102 may calculate θ satisfying Expression (2) below.

[Expression 2]

Minimize∥y−Σθᵢfᵢ∥ (2)

In Expression (2), i may indicate a shelf of the rack.

θ may be a result of the data analysis performed by the analysis processor 102 using the analysis data (analysis result) and may be, for example, θ=(5.0, 8.0, 1.2, 2.4, 0.6) as illustrated in FIG. 5. Each component of θ, which is an analysis result in the present exemplary embodiment, may indicate a weight of the relevant shelf of the rack. A component having a larger weight may indicate that the relevant shelf produces a higher sales amount. In the analysis result example illustrated in FIG. 5, the sales for the second shelf are the highest. As described above, the data analysis apparatus 10 according to the present exemplary embodiment can specify a position of a shelf that produces highest sales.

The analysis result of the analysis performed by the analysis processor 102 can be used, for example, as data for sales forecasting and/or optimum placement of products. A captured image captured by the imaging apparatus 20 may also be referred to as a learning image, and analysis data used for analysis, or merged data or extracted data, which is source data for analysis data, may also be referred to as learning data. An analysis result may also be referred to as a learning result.

The present exemplary embodiment has been described in terms of a case where a least-squares method is used as an analysis method for the analysis processor 102 to perform data analysis using the identification result and the commodity exchange data as an example. in some instances, the analysis method may not be limited to this example. As the analysis method, the analysis processor 102 may use a regression analysis method such as a least-squares method such as mentioned above or a classification method.

For example, where the above-described y is a specific value such as a sales amount or a sales volume, the analysis processor 102 may perform analysis using a regression analysis method. For the regression analysis method, for example, any of linear regression, maximum-likelihood estimation, Bayesian linear regression, neural network in addition to a least-squares method such as mentioned above may be used.

For example, if the y indicates a degree of sales, the analysis processor 102 may perform analysis using a classification method. The degree of sales may be, for example, a value indicated on a scale of one to ten according to the sales. For the classification method, for example, a generative model such as naive Bayes, logistic regression, support vector machine, neural network, nearest neighbor classification or decision tree may be used. As described above, the analysis processor 102 in the data analysis apparatus 10 according to the present exemplary embodiment can arbitrarily select an analysis method according to the content of learning data (for example, the type of the value of y).

For the data used as analysis data, the feature vectors mentioned above may be used as they are or feature vectors resulting from the feature vectors being converted using a mapping function.

### (Effects)

As described above, the identification processor 101 in the data analysis apparatus 10 according to the present exemplary embodiment may identify products included in a captured image, and locate placement positions of the products. Each of the placement positions of the products may include a position of a shelf in a shop rack on which the product is placed. The analysis processor 102 may analyze connection between a positional relation between the products and sales of the products based on the positions of the shelves of the shop rack for the plurality of products and commodity exchange data for the products.

In a shop rack including plural shelves, one or more products of one or more types may be placed. In a shop rack, a product having a certain product name and another product having a product name that is the same as or different from the product name may be often placed side by side vertically or horizontally. A shop rack may accommodate plural products placed on the respective shelves as described above. A result of analysis by the analysis processor 102 in the data analysis apparatus 10 according to the present exemplary embodiment may indicate a weight of each shelf. Therefore, the data analysis apparatus 10 can be regarded as being able to output an analysis result with connection between a positional relation between a product placed on a certain shelf and a product placed on another shelf, and sales of the products taken into consideration.

On a shelf that produces highest sales, one or more products, sales of which are relatively high, may be often placed. Therefore, the data analysis apparatus 10 according to the present exemplary embodiment can output an analysis result with a positional relation between products in which plural products, sales of which are relatively high, are placed, and sales of the products taken into consideration.

By outputting such analysis result, the data analysis apparatus 10 according to the present exemplary embodiment can provide more useful information that can be used for optimum placement of products.

### Second Example

A second example of the present disclosure will be described with reference to the drawings.

In the above-described first example, the analysis processor 102 may extract shelves of a shop rack in rack position information for products and sales amount of the products from merged data as information for analysis, and perform data analysis using the extracted data. In some instances, the information for analysis may not be limited to this case. The present exemplary embodiment will be described in terms of an example in which product names are included as information for analysis. The present exemplary embodiment will be described using sales amounts as commodity exchange data. In some instances, the commodity exchange data may include sales amounts or other information.

A configuration of a data analysis system 1 and a functional configuration of a data analysis apparatus 10 in the data analysis system 1 in the present exemplary embodiment may be similar to those of the first example

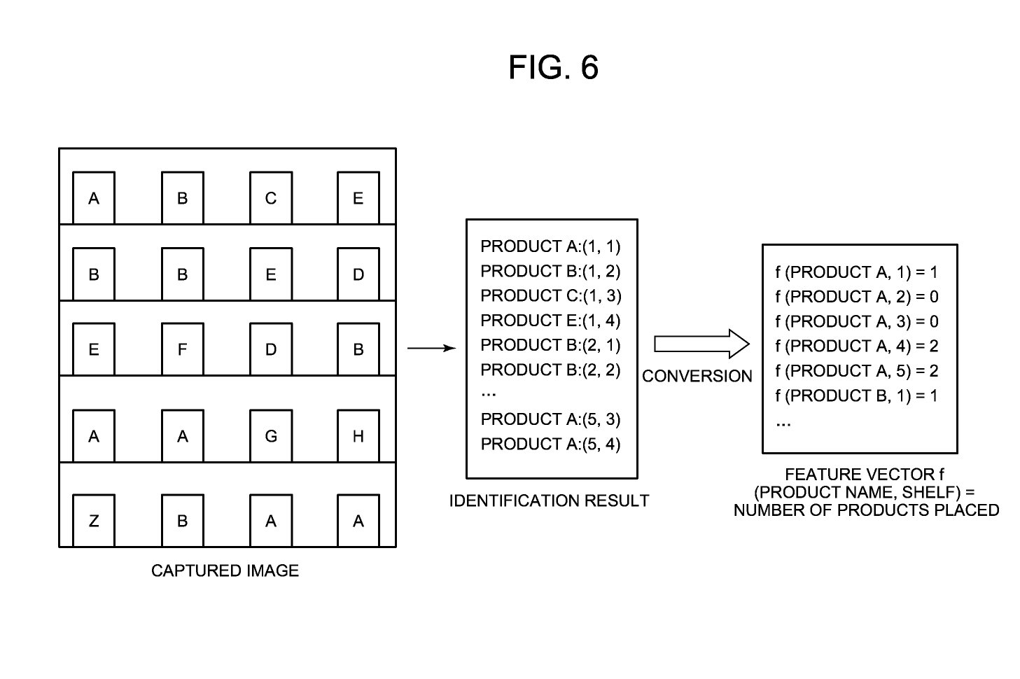

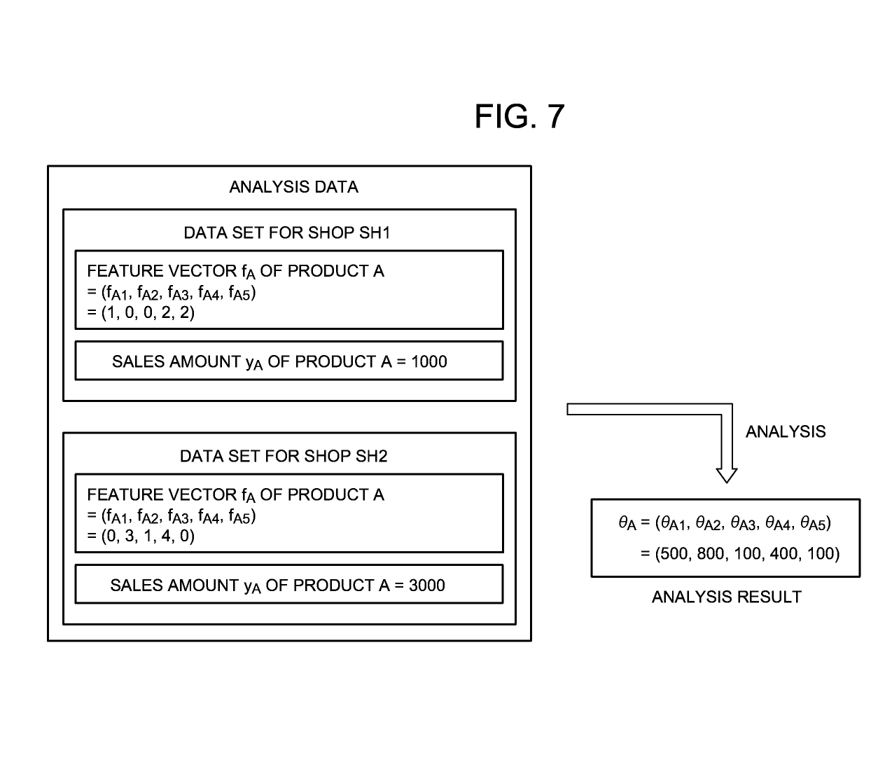

Operation of an analysis processor 102 in the data analysis apparatus 10 according to the present exemplary embodiment will be described with reference to FIGS. 6 and 7. Each of FIGS. 6 and 7 is a diagram for describing operation of the analysis processor 102 according to at least one exemplary embodiment.

The present exemplary embodiment will be described assuming that an imaging apparatus 20 captured an image such as illustrated in the left side of FIG. 6. Where the captured image is an image such as illustrated on the left side of FIG. 6, the identification processor 101 may output an identification result such as illustrated approximately in a center of FIG. 6.

The analysis processor 102 may convert the identification result into feature vectors f with a product name and a shelf of a shop rack as variables (product name, shelf). In the present exemplary embodiment, as illustrated in the right side of FIG. 6, each component of a feature vector f can be expressed by the number of a certain product placed on a certain shelf. In other words, “f (product A, 1)=1” may indicate that one product whose product name is “product A” is placed on a first shelf of a shop rack.

The analysis processor 102 may perform data analysis for each product name. In FIG. 7, data analysis of a product whose product name is “product A” will be described. Analysis data used in the present exemplary embodiment may be the data illustrated on the left side of FIG. 7. In the present exemplary embodiment, data including two data sets below may be used as analysis data:

(1) Data set including a feature vector of Product A in a shop SH1 and a sales amount (y_{A}) of Product A in the shop, which is illustrated on the upper left side of FIG. 7; and
(2) Data set including a feature vector of Product A in a shop SH2 and a sales amount (y_{A}) of Product A in the shop, which is illustrated on the lower left side of FIG. 7.

The analysis data may not be limited to that including two sets and may be that including plural data sets. The present exemplary embodiment will be described in terms of an example in which two sets of data for different shops are used. In some instances, the data sets may be ones generated from commodity exchange data of different dates and times in one shop.

A feature vector f_{A} of Product A may include components. The number of components included in the feature vector f_{A} may correspond to the number of shelves of a rack. The value of each component may indicate the number of the products placed as described above. The numerical part X of the subscript AX to each component f_{Ax} may indicate what number shelf of the rack the relevant shelf is. For example, f_{A1} may indicate a first shelf of the rack, and the value of f_{A1} may indicate the number of products A placed on the first shelf of the rack. In the figure on the right side of FIG. 6, one Product A is placed on the first shelf of the rack, no Products A are placed on second and third shelves, and two Products A are placed on each of fourth and fifth shelves. Therefore, the feature vector f_{A} of Product A used as analysis data in the present exemplary embodiment may be expressed as f_{A}=(1, 0, 0, 2, 2).

The analysis processor 102 may calculate θ_{A} satisfying Expression (3) below using the analysis data.

[Expression 3]

Minimize|y_{A}−Σθ_{Ai}f(A,i)| (3)

In Expression (3), i may indicate a shelf of the rack (i=1, 2, 3, 4, 5).

θ_{A} may be a result of the data analysis performed by the analysis processor 102 using the analysis data (analysis result) and may be, for example, θ_{A}=(500, 800, 100, 400, 100) as illustrated in FIG. 7. Each component θ_{Ai} of θ_{A}, which is an analysis result in the present exemplary embodiment, may indicate a weight of the relevant shelf of the rack for Product A. A component having a larger weight may indicate that the relevant shelf produces higher sales of Product A. According to the analysis result example illustrated in FIG. 7, the sales of product A placed on the second shelf are highest. As described above, the data analysis apparatus 10 according to the present exemplary embodiment can specify a position of a shelf producing highest sales for each product name.

As in the first example, an analysis method in the analysis processor 102 of the present exemplary embodiment may not be limited to a least-squares method, and may be any of various methods described in the first example.

The analysis processor 102 according to the present exemplary embodiment may use a sale amount as a value of y_{A} used for analysis. In some instances, the analysis processor 102 may use a sale volume. In this case, if commodity exchange data includes a sales amount of a certain product and a unit price of the product, but does not include a sales volume of the product, the analysis processor 102 may obtain the sales volume by dividing the sales by the unit price and use the sales volume as the value of y_{A}.

In the present exemplary embodiment, data analysis may be performed for each product name indicating a product. In some instances, any unit for data analysis may be employed as long as such unit is one that can identify a product such as a product identifier.

### (Effects)

As described above, the data analysis apparatus 10 according to the present exemplary embodiment may provide a weight of each shelf for each product name as an analysis result. As described above, the data analysis apparatus 10 can output an analysis result with more consideration of connection between a positional relation between products and commodity exchange data, for each product name. Therefore, the data analysis apparatus 10 according to the present exemplary embodiment may enable provision of more useful information that can be used for providing optimum placement of products.

### Third Example

A third example of the present disclosure will be described with reference to the drawings.

The above second example has been described in terms of an example in which product names are included in information for analysis. In some aspects, the information for analysis may not be limited to this example. The present exemplary embodiment will be described in terms of a configuration in which information for analysis may include product category names indicating product categories (also simply referred to as categories) instead of product names. The present exemplary embodiment will be described with sales amounts employed as commodity exchange data. In some instances, the commodity exchange data may include sales amounts or other information. The present exemplary embodiment will be described in terms of an example in which an analysis processor 102 performs data analysis using a least-squares method, as with the analysis processor 102 in each of the above-described exemplary embodiments. In some instances, another analysis method may be used.

A configuration of a data analysis system 1 according to the present exemplary embodiment may be similar to that of the first example.

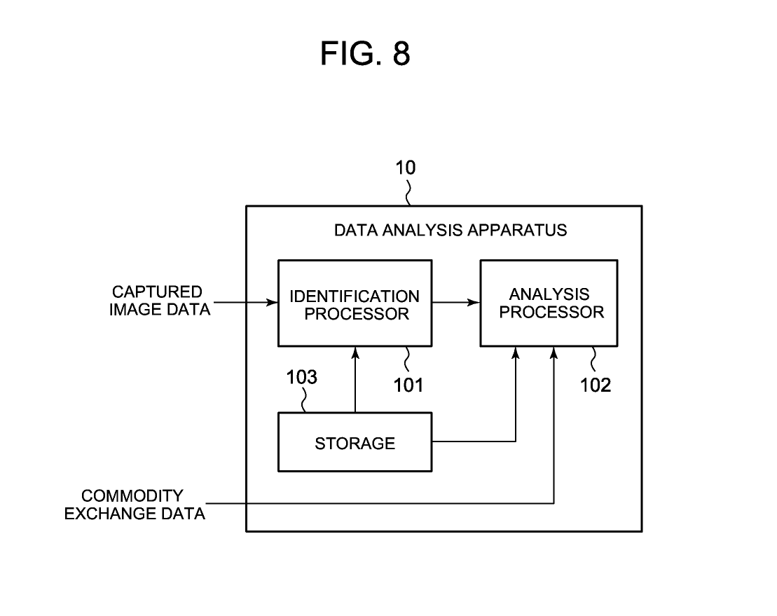

FIG. 8 is a functional block diagram illustrating an example of a functional configuration of a data analysis apparatus 10 according to at least one exemplary embodiment. As in the first and second examples, the data analysis apparatus 10 illustrated in FIG. 8 may include an identification processor 101, the analysis processor 102 and a storage 103. The data analysis apparatus 10 may be different from the data analysis apparatus 10 illustrated in FIG. 2 in that the analysis processor 102 refers to information in the storage 103. In the above-described first and second examples, the analysis processor 102 may be configured so as to refer to information in the storage 103 as illustrated in FIG. 8.

The storage 103 according to the present exemplary embodiment may store data associating products and product categories of the products with each other (product category data) in addition to product images which are described in the first example.

The storage 103 according to the present exemplary embodiment may be separated from a storage in which the product images are stored. The product category data may be associated with product identifiers. A part of the storage 103 that stores the product category data may be one incorporated in the analysis processor 102. The storage 103 may be provided by a storage apparatus that is separated from the data analysis apparatus 10.

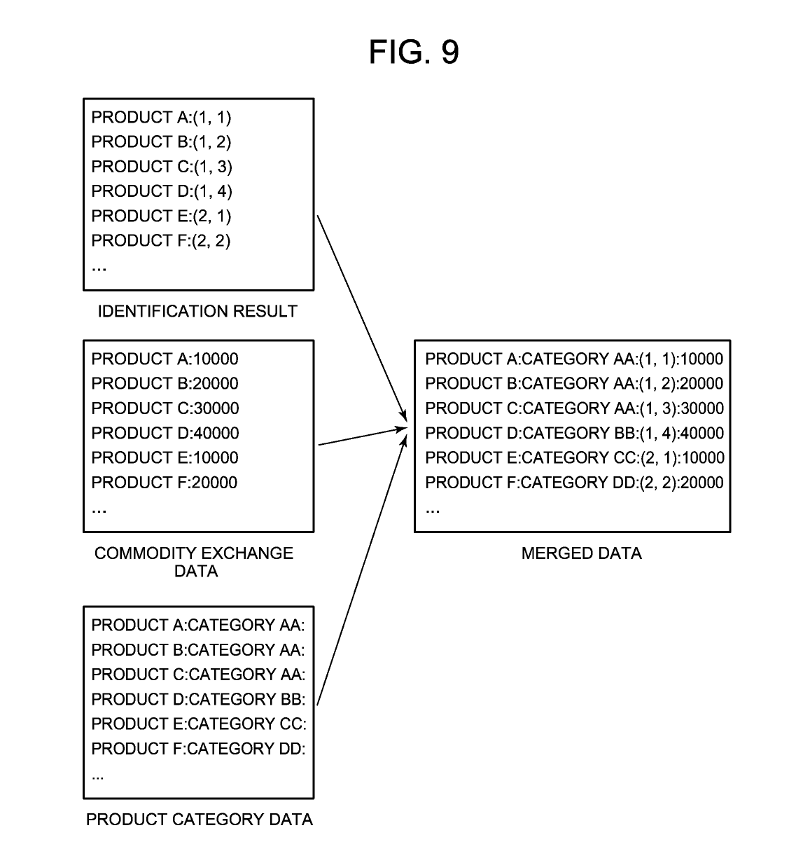

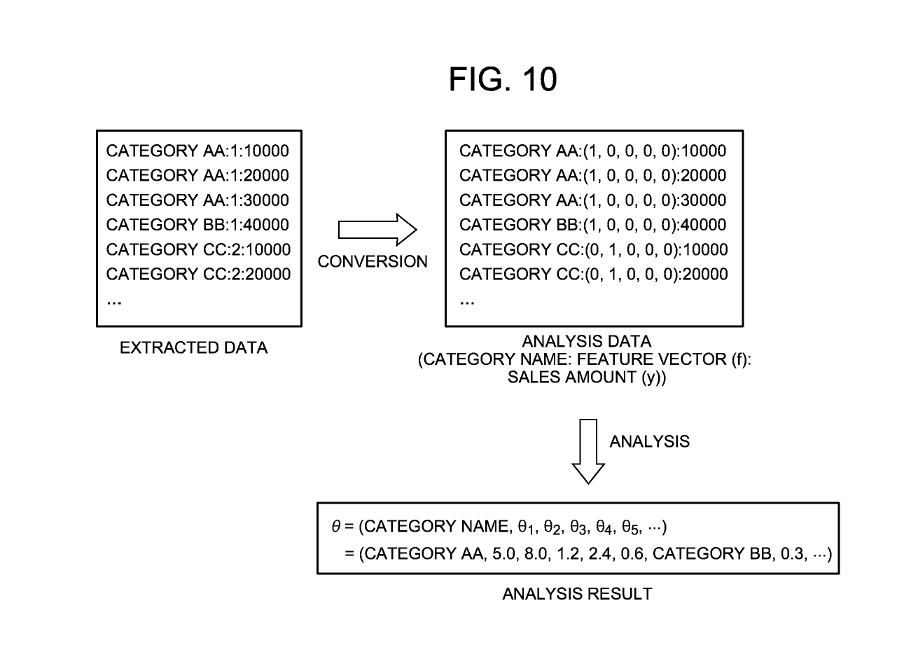

Operation of the analysis processor 102 will be described with reference to FIGS. 9 and 10. Each of FIGS. 9 and 10 is a diagram for describing operation of the analysis processor 102 according to at least one exemplary embodiment.

In FIG. 9, the figure positioned on the upper left side may indicate output data (identification result) output by the identification processor 101, which is received by the analysis processor 102 from the identification processor 101. The identification result may be similar to that illustrated in the upper left side of FIG. 4. In FIG. 9, the figure positioned on the middle left side may indicate an example of commodity exchange data received by the analysis processor 102 from a POS system 30. The commodity exchange data may be similar to that illustrated on the lower left side of FIG. 4. In FIG. 9, the figure positioned on the lower left side may indicate an example of the product category data stored in the storage 103. In FIG. 9, the figure positioned on the right side may indicate an example of merged data resulting from the identification result, the commodity exchange data and the product category data being merged.

As illustrated in FIG. 9, the product category data may be data associating product names of products, and product category names indicating product categories of the products with each other. The identification result, the commodity exchange data and the product category data illustrated in FIG. 9 may be examples and they may not be limited to these examples.

The analysis processor 102 may specify records (elements) for a product name in the identification result, a product name in the commodity exchange data and a product name in the product category data, the product names corresponding to one another. From the records for the product names corresponding to one another, the analysis processor 102 may generate merged data associating (1) the product name, (2) an element associated with the product name in the identification result, (3) an element associated with the product name in the commodity exchange data, and (4) an element associated with the product name in the product category data with one another. In other words, in the present exemplary embodiment, the analysis processor 102 may generate merged data associating (1) a product name, (2) rack position information for a product indicated by the product name, (3) a sales amount of the product indicated by the product name and (4) a product category name of the product indicated by the product name with one another. For example, rack position information for a product whose product name is “Product A” may be (1, 1) as illustrated in the identification result, a sales amount of the product may be “10000” as illustrated in the commodity exchange data, and a product category name of the product may be “Category AA”. The analysis processor 102 may merge these to generate merged data “Product A: Category AA: (1, 1): 10000”. As described above, the analysis processor 102 may associate elements associated with a certain product name, with one another.

In the above example, the product names may be used as an example of product information for associating the elements included in the identification result and the elements included in the commodity exchange data. In some instances, as described in the first example, product identifiers may be used. The order of merging in the merged data may not be limited to that of this example, and may be required to be one indicating that the product names, the product category names, shelves of a rack, and sales amounts are associated with one another, respectively.

The analysis processor 102 may extract information for analysis from the merged data. In the present exemplary embodiment, as information for analysis, the product category names, the shelves of the rack in the rack position information for the products, and the sales amounts may be used.

In the present exemplary embodiment, as information for analysis, the product category names, the shelves of the rack in the rack position information for the products, the sales amounts of the product may be used. Therefore, as illustrated in FIG. 10, the extracted data may be one resulting from the product category names, the shelves of the rack and the sales amounts being extracted from the merged data. In the merged data, the product category names, the rack position information including the shelves of the rack, and the sales amounts may be associated with one another, and therefore, the product category names, the shelves of the rack and the sales amounts included in the extracted data may be associated with one another. In FIG. 10, this association is expressed using colons (:).

The analysis processor 102 may convert the extracted data with the shelves of the rack and the sales amounts associated with each other into analysis data, which is data that can be subjected to data analysis. A method of this conversion may be similar to that of the first example described above.

The analysis processor 102 may perform data analysis using the analysis data, for each product category. For example, θ which is an analysis result of the data analysis performed by the analysis processor 102 using the analysis data may be that illustrated in FIG. 10.

In the analysis result illustrated in FIG. 10, as components of the analysis result, a product category name and a weight of each shelf for a product category indicated by the product category name may be included for each product category. In other words, the respective components of the analysis result following the product category “Category AA” may be a weight of a first shelf, a weight of a second shelf, . . . and a weight of a fifth shelf for product category AA.

As in the above-described second example, the analysis processor 102 may perform analysis on a product category-by-product category basis. In the analysis result, a component having a larger weight may indicate a shelf producing higher sales of products of the relevant product category. In the example of the analysis result illustrated in FIG. 10, the sales of products of Category AA placed on the second shelf are the highest. As described above, the data analysis apparatus 10 according to the present exemplary embodiment can specify, for each product category, a position of a shelf producing highest sales of products of the product category.

The product category data may be, for example, information included in commodity exchange data, rather than that stored in the storage 103, or may be that obtained via a network 40 from another apparatus.

### (Effects)

As described above, the data analysis apparatus 10 according to the present exemplary embodiment may use a weight of each shelf as an analysis result for each product category. As described above, the data analysis apparatus 10 can output an analysis result with more consideration of connection between a positional relation between products and commodity exchange data, for each product category. Therefore, the data analysis apparatus 10 according to the present exemplary embodiment may enable provision of more useful information that can be used for providing optimum placement of products using product categories.

### Fourth Example

A fourth example of the present disclosure will be described with reference to the drawings. The above-described second and third examples have been described in terms of examples in which product names or product categories of products, sales of which are to be recognized, may be included in information for analysis. In some instances, the information for analysis may not be limited to these examples. Information for analysis may include product names or categories of products placed adjacent to products, sales of which are to be recognized.

Purchasers may sometimes buy a product near a product they intends to buy. Therefore, the present exemplary embodiment will be described in terms of an example in which data analysis is performed using information for a product adjacent to at least one of the left and the right of a certain product.

The present exemplary embodiment will be described with sales amounts employed as commodity exchange data. In some instances, the commodity exchange data may include sales amounts or other information. The present exemplary embodiment will be described in terms of an example in which an analysis processor 102 performs data analysis using a least-squares method. In some instances, as with the analysis processor 102 in each of the above-described exemplary embodiments, another analysis method may be used.

A configuration of a data analysis system 1 and a functional configuration of a data analysis apparatus 10 in the data analysis system 1 in the present exemplary embodiment may be similar to those of the first example.

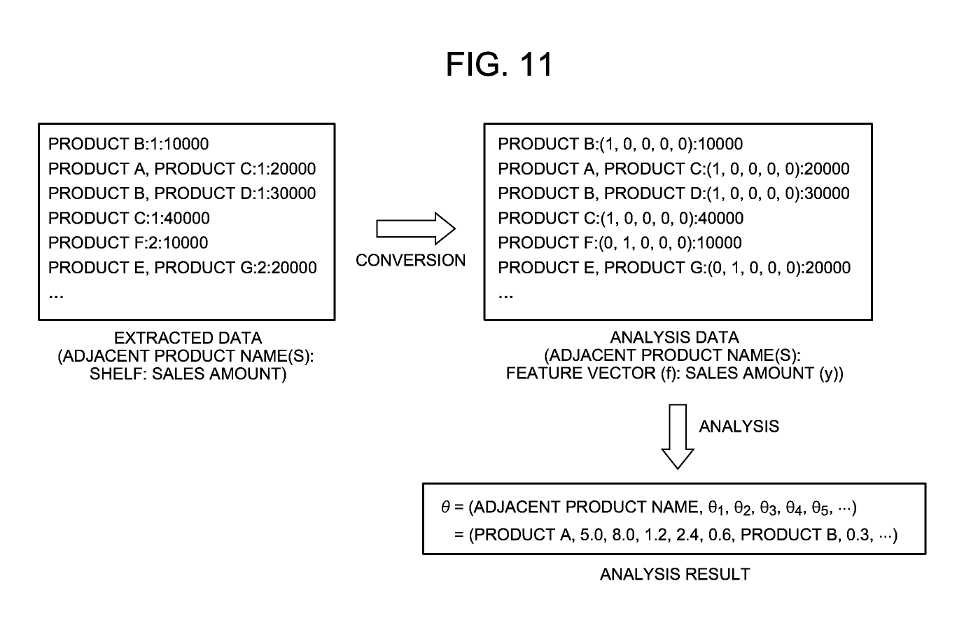

Operation of the analysis processor 102 will be described with reference to FIG. 11. FIG. 11 is a diagram for describing operation of the analysis processor 102 according to at least one exemplary embodiment.

The analysis processor 102 in the data analysis apparatus 10 according to the present exemplary embodiment may extract information for analysis from the merged data illustrated in FIG. 4. In the present exemplary embodiment, as information for analysis, shelves of a rack on which products indicated by product names are placed in rack position information for products, sales amounts of the products and product names of products adjacent to the products (adjacent product names) may be used.

The adjacent product names may be ones obtained by the analysis processor 102 from the rack position information for the respective products included in the merged data. For example, rack position information for Product C is (1, 3), and thus, rack position information for products adjacent to Product C is (1, 2) and (1, 4). Therefore, the analysis processor 102 may search for products having the rack position information in the merged data, and specify product names obtained from a result of the search as adjacent product names for Product C.

The adjacent product names may be ones included in a result of identification by an identification processor 101. For example, when the identification processor 101 identifies products and specifies positions at which the products are placed, the identification processor 101 may identify products placed at respective positions adjacent to the specified positions, and supply an identification result including adjacent product names indicating the adjacent products to the analysis processor 102.

The extracted data illustrated in FIG. 11 may include an adjacent product name of an adjacent product adjacent to a certain product (Product A in the case of the first record in the extracted data), a shelf for the certain product, and a sales amount of the certain product. Where there are plural products adjacent to each of products, each of the relevant records in the extracted data may include plural adjacent product names. In this case, the extracted data may or may not include information indicating whether the adjacent products stand to the right or to the left of the certain product. For example, the information of indication of which of the left and the right of the relevant product is adjacent to each of the adjacent products may include adjacent product names, and may be, “the adjacent product name of the adjacent product adjacent to the right of the relevant product, the adjacent product name of the adjacent product adjacent to the left of the relevant product”. Where a product is placed on a right end or a left end of a shelf of a rack, information indicating that no products can be placed may be included as an adjacent product name of an adjacent product adjacent to the right side or the left side.

The analysis processor 102 may convert the extracted data into analysis data, which is data that can be subjected to data analysis. A method of the conversion may be similar to that of the above-described first example.

The analysis processor 102 may perform data analysis using the analysis data, for each adjacent product name. For example, θ which is an analysis result of the data analysis performed by the analysis processor 102 using the analysis data may be that illustrated in FIG. 11.

The analysis result illustrated in FIG. 11 may include, for each adjacent product name, the adjacent product name, weights of the respective shelves for a product indicated by the adjacent product name as components of the analysis result. In other words, the respective components of the analysis result that follows the product of the adjacent product name “Product A” may be a weight of a first shelf, a weight of a second shelf, . . . and a weight of a fifth shelf for a product adjacent to Product A.

As in the above-described second example, the analysis processor 102 may perform analysis on an adjacent product name-by-adjacent product name basis. In this analysis result, a component having a larger weight may indicate a shelf producing higher sales of product(s) adjacent to a product indicated by an adjacent product name. Therefore, in the analysis result example illustrated in FIG. 11, sales of the product adjacent to the product of the adjacent product name “Product A” is the highest on the second shelf. As described above, the data analysis apparatus 10 according to the present exemplary embodiment can specify, for each adjacent product name, a position of a shelf producing highest sales of product(s) adjacent to the relevant adjacent product.

In the present exemplary embodiment, the analysis processor 102 may be configured so as to perform analysis for a product adjacent to both Product A and Product C as illustrated in the second row in the analysis data in FIG. 11 or may be configured so as to perform analysis for a product adjacent to at least one of Product A and Product C.

Where information of indication of which of the left and the right of the relevant product is adjacent to each of the adjacent products is included, the analysis processor 102 may perform data analysis, with the positions of the adjacency included, that is, for example, for each adjacent product name of an adjacent product adjacent to the right side.

In the present exemplary embodiment, feature vectors may be generated using information indicating whether or not there are product(s) adjacent to an adjacent product name, to perform data analysis. In some instances, data analysis may be performed using the number of products adjacent to an adjacent product name as with the analysis processor 102 described in the second example.

As described above, the data analysis apparatus 10 according to the present exemplary embodiment can output an analysis result with more consideration of connection between a positional relation between products and commodity exchange data, for each adjacent product name. Therefore, the data analysis apparatus 10 according to the present exemplary embodiment may enable provision of more useful information that can be used for providing optimum placement of products using adjacent products.

### (Variation 1)

Variation 1 of the present exemplary embodiment will be described. In the above-described fourth example, data analysis may be performed using a product name of a product adjacent to at least one of the left and the right of each of certain products. In some instances, the data analysis may not be limited to this case. As in the above-described third example, data analysis may be performed using product categories instead of product names.

A configuration of a data analysis system 1 according to the present variation may be similar to that of the first example. A functional configuration of a data analysis apparatus 10 according to the present variation may be similar to that of the third example.

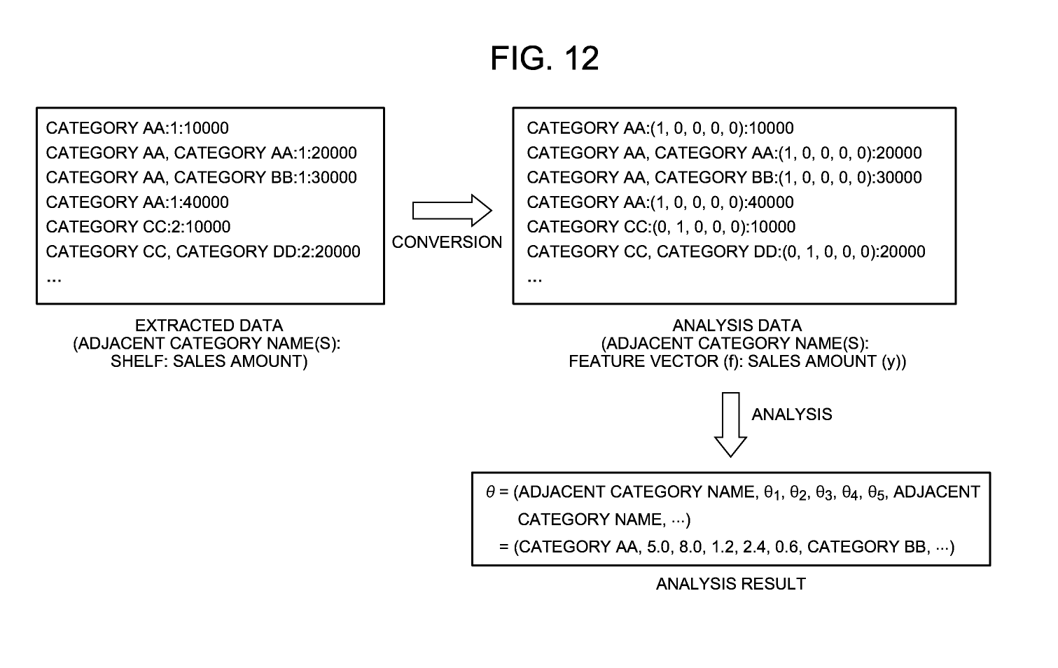

Operation of an analysis processor 102 will be described with reference to FIG. 12. FIG. 12 is a diagram for describing operation of an analysis processor 102 according to at least one exemplary embodiment.

In the present variation, the analysis processor 102 may generate extracted data to be used in the present variation, using the extracted data used in the above-described fourth example and product category data stored in a storage 103. In some instances, by referring to the product category data, adjacent product names in the extracted data illustrated in FIG. 11 may be replaced with product category names of products indicated by the adjacent product names. The product category names may be also referred to as adjacent category names.

Consequently, an example of the extracted data generated by the analysis processor 102 may be data such as illustrated on the left side of FIG. 12. A method of generating extracted data according to the present variation may not be limited to the above-description. In some instances, a method in which extracted data is generated using captured image data may be employed. In this case, as in the above-described fourth example, the extracted data may include or not include information of indication of which of the left and the right of the relevant product is adjacent to each of the adjacent products.

The analysis processor 102 may convert the extracted data into analysis data that can be subjected to data analysis. A method for the conversion may be similar to that of the above-described first example.

The analysis processor 102 may perform data analysis using the analysis data, for each adjacent category name. For example, θ which is an analysis result of the data analysis performed by the analysis processor 102 using the analysis data may be that illustrated in FIG. 12.

The analysis result illustrated in FIG. 12 may include an adjacent category name and a weight of each shelf for a product category indicated by the adjacent category name, for each product category, as components of the analysis result. For example, the respective components of the analysis result following the product category “Category AA” may be a weight of a first shelf, a weight of a second shelf, . . . and a weight of a fifth shelf for product category AA.

As in the above-described second example, the analysis processor 102 may perform analysis on an adjacent category-by-adjacent category basis. In the analysis result, a component having a larger weight may indicate a shelf producing higher sales of product(s) adjacent to an adjacent product of the relevant adjacent category. In the example of the analysis result illustrated in FIG. 12, sales of products adjacent to the adjacent products whose adjacent category names are “Category AA” are the highest on the second shelf. As described above, the data analysis apparatus 10 according to the present variation can specify, for each adjacent category, a position of a shelf producing highest sales of product(s) adjacent to an adjacent product of the adjacent category.

In the present variation, the analysis processor 102 may be configured so as to perform analysis for a product adjacent to both of an adjacent product of Category AA and an adjacent product of Category AA as illustrated in the second row in the analysis data in FIG. 12 or may be configured so as to perform analysis for a product adjacent to at least one of the adjacent product of Category AA and the adjacent product of Category AA.

In the present variation, feature vectors may be generated using information indicating whether or not there are products adjacent to the adjacent products of Category AA to perform data analysis, as with the analysis processor 102 described in the second example, data analysis may be performed using the number of products adjacent to products of a product category of an adjacent category name (adjacent product).

As described above, the data analysis apparatus 10 according to the present variation can output an analysis result with more consideration of connection between a positional relation between products and commodity exchange data, for each adjacent category. Therefore, the data analysis apparatus 10 according to the present variation may enable provision of more useful information that can be used for providing optimum placement of products using product categories of adjacent products.

### (Variation 2)

Variation 2 of the present exemplary embodiment will be described. In some cases, products placed in a shop rack may be sold out. The present variation will be described in terms of a case where an adjacent product is sold out.

A configuration of a data analysis system 1 and a functional configuration of a data analysis apparatus 10 in the data analysis system 1 in the present variation may be similar to those of the first example.

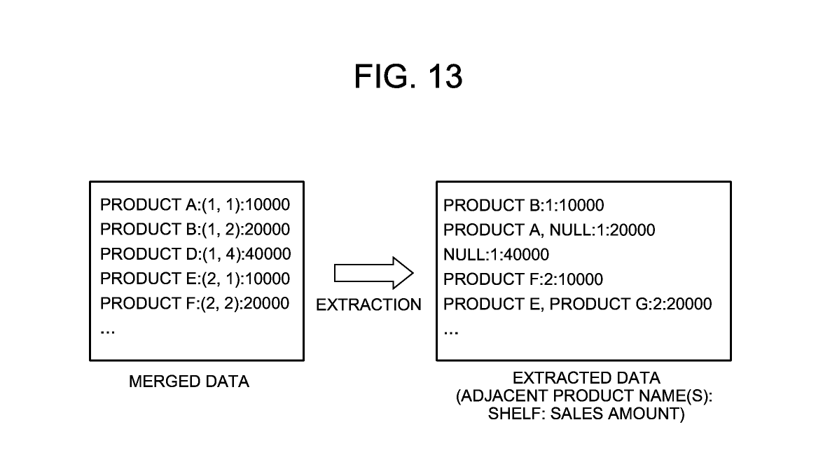

Operation of an analysis processor 102 will be described with reference to FIG. 13. FIG. 13 is a diagram for describing operation of an analysis processor 102 according to at least one exemplary embodiment.

An example in which the analysis processor 102 may generate merged data such as illustrated in FIG. 13 will be described. For example, it is assumed that the product in the third column of the first shelf (Product C in FIG. 3) in the captured image illustrated on the left side of FIG. 3 is sold out. In this case, Product C may not be included in the captured image, and thus, an identification result output by an identification processor 101 may not include information indicating that Product C is placed in the third column of the first shelf.

Therefore, merged data generated by the analysis processor 102 may not include a record of “Product C: (1, 3)”. From such information, the analysis processor 102 can determine whether or not the product adjacent to Product B is sold out. For example, to indicate that the product adjacent to Product B is sold out, the analysis processor 102 may specify that the extracted data for the adjacent location is “NULL”.

As in the fourth example, the analysis processor 102 may perform data analysis for each adjacent product name. Further, the analysis processor 102 according to the present variation may perform data analysis based on sold-out information (“NULL” described above) for the adjacent product.

As described above, the data analysis apparatus 10 according to the present variation can further perform data analysis based on sold-out information for an adjacent product. Consequently, the data analysis apparatus 10 can output an analysis result including information indicating that the adjacent product is sold out.

The present variation has been described using adjacent product names as data used for analysis. In some instances, adjacent category names can also be used as in Variation 1.

In the present variation, feature vectors may be generated using information indicating whether or not adjacent product(s) are sold out to perform data analysis. In some instances, as in the analysis processor 102 described in the second example, data analysis may be performed using information indicating how many positions at which adjacent product(s) are sold out there are.

### (Variation 3)

Variation 3 of the present exemplary embodiment will be described. In the fourth example and variations 1 and 2 described above, data analysis may be performed using a product name, a product category name or sold-out information for a product adjacent to at least one of the right or the left of a certain product. In some instances, the method of data analysis may not be limited to this case. The present variation will be described in terms of an example in which data analysis is performed in consideration of products adjacent to a certain product, the products being located plural products away from the certain product.

A configuration of a data analysis system 1 and a functional configuration of a data analysis apparatus 10 in the data analysis system 1 in the present variation may be similar to those of the first example.

As in the fourth example, the present variation will be described in terms of a case where data analysis is performed using adjacent product names. In some instances, as in Variation 1, adjacent category names may be used or as in Variation 2, sold-out information may be used.

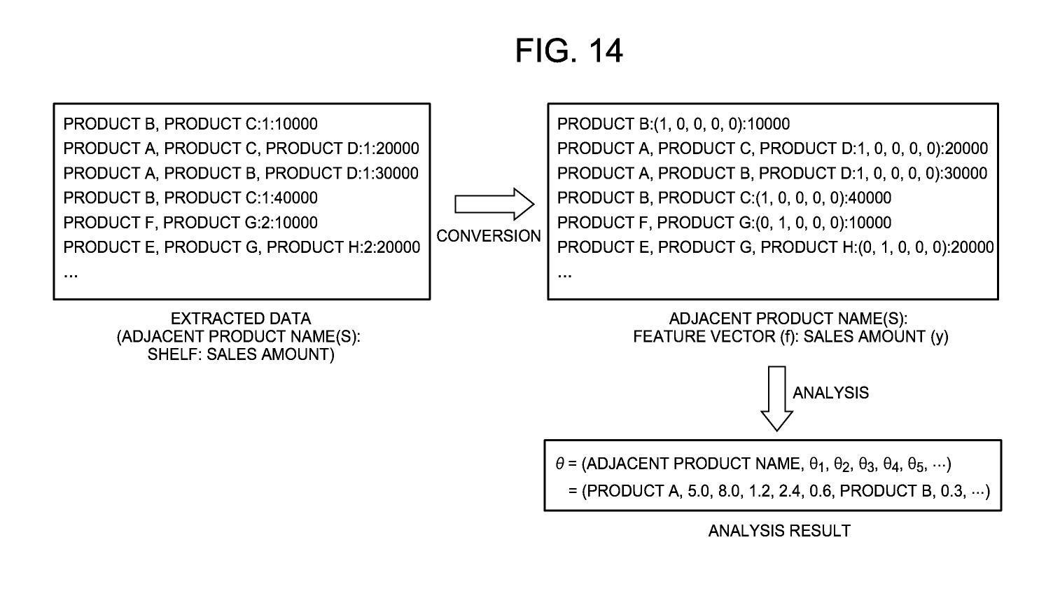

Operation of an analysis processor 102 will be described with reference to FIG. 14. FIG. 14 is a diagram for describing operation of the analysis processor 102 according to at least one exemplary embodiment.

The analysis processor 102 in the data analysis apparatus 10 according to the present variation may extract information for analysis from the merged data illustrated in FIG. 4. In the present variation, as information for analysis, shelves of a rack on which products indicated by product names are placed in rack position information for the products, sale amounts of the products and adjacent product names of adjacent products adjacent to the respective products within a predetermined range may be used. The predetermined range may be one that can be set by a user. In the present variation, the predetermined range may be a range of two products away on the left and the right of a relevant product.

A method of obtaining the adjacent product names may be similar to the method described in the fourth example.

The extracted data illustrated in FIG. 14 may include adjacent product names of adjacent products adjacent to each of certain products, shelves for the certain products and sales amounts of certain products. Where there are plural adjacent products, each of the relevant records in the extracted data may include plural adjacent product names. In this case, the extracted data may include or not include information indicating the number between the relevant product and the adjacent product, and the information of indication of which of the left and the right of the relevant product is adjacent to each of the adjacent products.

The analysis processor 102 may convert the extracted data into analysis data, which is data that can be subjected to data analysis, and perform data analysis for each adjacent product name. When the extracted data includes information indicating the number of spaces between the relevant product and the adjacent product and information indicating the direction of the adjacent product with respect to the relevant product (e.g., left or right), the analysis processor 102 may perform data analysis with positions of adjacency included, for example, for each of adjacent product names of adjacent products that are second adjacent products on the right side.

A result of the analysis by the analysis processor 102 may be similar to that of the above-described fourth example.

As described above, the data analysis apparatus 10 according to the present variation may perform data analysis, using information for adjacent products adjacent to each of products, for which the data analysis is performed, within a predetermined range. Consequently, the data analysis apparatus 10 can output an analysis result with more consideration of connection between a positional relation between products and commodity exchange data.

### Fifth Example

A fifth example of the present disclosure will be described with reference to the drawings.

In the fourth example and Variations 1 to 3 described above, the data analysis apparatus 10 may perform data analysis using information for products adjacent to the left and/or the right of each of products. In some instances, the method of data analysis may not be limited to this case. The present exemplary embodiment will be described in terms of an example in which data analysis is performed using information for adjacent product(s) adjacent to at least one of the top and the bottom of each of products for which the data analysis is performed.

The present exemplary embodiment will be described with sales amounts employed as commodity exchange data. In some instances, the commodity exchange data may include sales amounts or other information. The present exemplary embodiment will be described in terms of an example in which an analysis processor 102 performs data analysis using a least-squares method. In some instances, as in the analysis processor 102 in each of the exemplary embodiments described above, another analysis method may be used.

A configuration of a data analysis system 1 and a functional configuration of a data analysis apparatus 10 in the data analysis system 1 in the present exemplary embodiment may be similar to those of the first example.

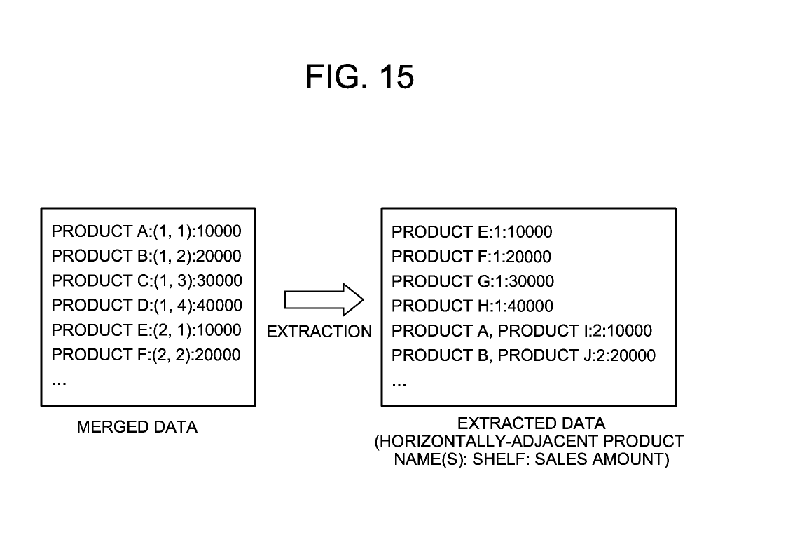

Operation of the analysis processor 102 will be described with reference to FIG. 15. FIG. 15 is a diagram for describing operation of the analysis processor 102 according to at least one exemplary embodiment.

The analysis processor 102 in the data analysis apparatus 10 according to the present exemplary embodiment may extract information for analysis from the merged data illustrated in FIG. 15. In the present exemplary embodiment, as information for analysis, shelves of a rack on which products indicated by product names are placed in rack position information for products, sales amounts of the products and product name(s) (referred to as vertically-adjacent product name(s)) of product(s) (vertically-adjacent product(s)) adjacent to the top and/or the bottom of each of the products may be used.

It may be assumed that the vertically-adjacent product names are obtained according to a method that is similar to the method of obtaining adjacent product names in the fourth example.

The extracted data illustrated in FIG. 15 may include a vertically-adjacent product name of a vertically-adjacent product adjacent to the top or the bottom of a certain product (Product A in the case of the first record in the extracted data), a shelf of the certain product and a sales amount of the certain product. Where there are plural adjacent products adjacent to the top or the bottom of products, each of the relevant records in the extracted data may include plural vertically-adjacent product names. In this case, the extracted data may include or not include information of indication of which of the top and the bottom of the product is adjacent to each vertically-adjacent product.

As in the fourth example, the analysis processor 102 may convert the extracted data into analysis data that can be subjected to analysis, and perform data analysis.

As described above, the data analysis apparatus 10 according to the present exemplary embodiment can output an analysis result with more consideration of connection between a positional relation between products and commodity exchange data, using information for vertically-adjacent products adjacent to the top or the bottom of relevant products. Therefore, the data analysis apparatus 10 according to the present exemplary embodiment can provide more useful information that can be used for providing optimum placement of products using vertically-adjacent products.

### Sixth Example

A sixth example of the present disclosure will be described with reference to the drawings.

In each of the first to fifth examples described above, as components of feature vectors, information regarding whether or not products are placed on each of shelves of a shop rack and the numbers of products may be used. In some instances, the components of feature vectors may not be limited to this case. The present exemplary embodiment will be described in terms of a method in which data analysis is performed without using information for each of shelves.

The present exemplary embodiment will be described with sales amounts employed as commodity exchange data. In some instances, the commodity exchange data may include sales amounts or other information. The present exemplary embodiment will be described in terms of an example in which an analysis processor 102 performs data analysis using a least-squares method. In some instances, as in the analysis processor 102 in each of the above-described exemplary embodiments, another analysis method may be used.

A configuration of a data analysis system 1 and a functional configuration of a data analysis apparatus 10 in the data analysis system 1 in the present exemplary embodiment may be similar to those of the first exemplary embodiment.

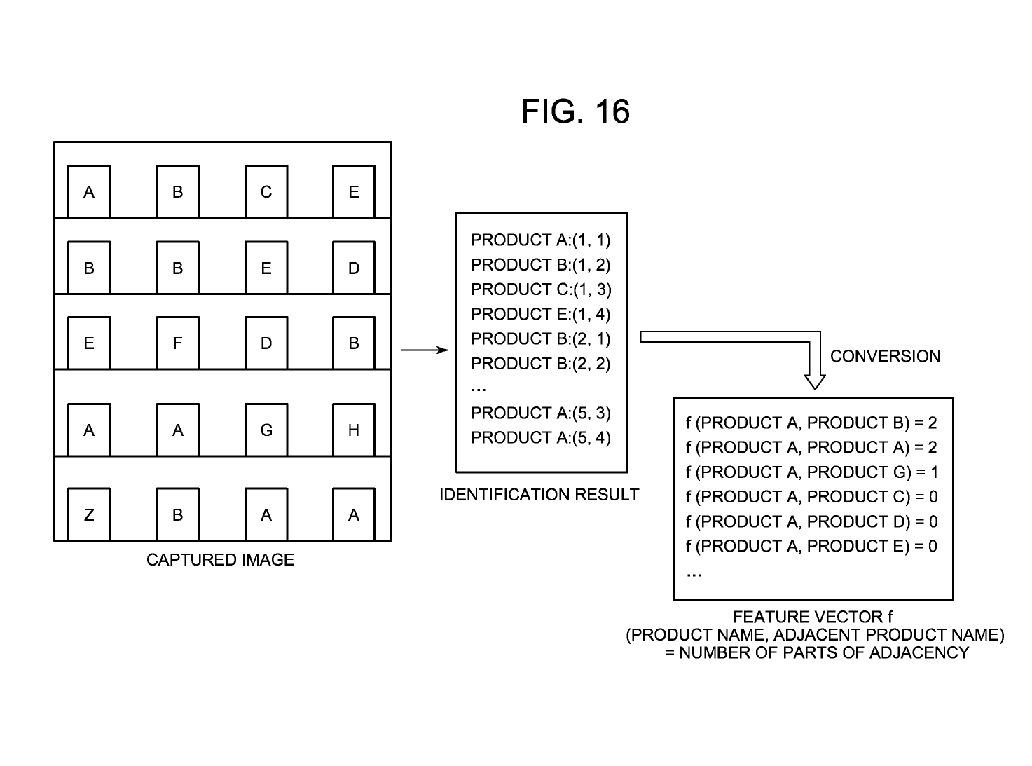

The present exemplary embodiment will be described assuming that an imaging apparatus 20 captured an image such as illustrated in the left side of FIG. 16. Where the captured image is an image such as illustrated on the left side of FIG. 16, an identification processor 101 may output an identification result such as illustrated approximately in a center of FIG. 16.

The analysis processor 102 may convert the identification result into feature vectors f with a product name and a name of an adjacent product adjacent to a product indicated by the product name as variables (product name, adjacent product name). In this case, in the present exemplary embodiment, as illustrated on the right side of FIG. 16, each component of a feature vector f can be expressed by the number of parts of adjacency between a certain product and an adjacent product adjacent to the product. For example, “f (Product A, Product B)=2” may indicate that there are two parts in which a product whose product name is “Product A” is adjacent to an adjacent product whose adjacent product name is “Product B”.

The analysis processor 102 may perform data analysis for each product name. In FIG. 17, data analysis for a product whose product name is “Product A” will be described. Analysis data used in the present exemplary embodiment may be the data illustrated on the left side of FIG. 17. In the present exemplary embodiment, data including two data sets below may be used as analysis data:

(1) Data set including a feature vector of Product A in a shop SH1 and a sales amount (y_{A}) of Product A in the shop, which is illustrated in the upper left side of FIG. 17; and
(2) Data set including a feature vector of Product A in a shop SH2 and a sales amount (y_{A}) of Product A in the shop, which is illustrated in the lower left side of FIG. 17.

The analysis data may not be limited to that including two sets and may be that including plural sets. The present exemplary embodiment will be described in terms of an example in which two sets of data for different shops are used. In some instances, the data set may ones generated from commodity exchange data of different dates and times in one shop.

A feature vector f_{A} of Product A may include components corresponding to the number of adjacent product names. A value of each component may indicate the number of parts of adjacency between products as described above. The first “A” in the subscript “AB” to each component f_{AB} may indicate that the component is a component of a feature vector of Product A, and the following part “B” of the subscript may indicate a name of an adjacent product adjacent to Product A. For example, f_{AB} may indicate that a name of an adjacent product adjacent to Product A is Product B, and a value of f_{AB} may indicate the number of parts of adjacency between Product A and Product B. In the figure on the right side of FIG. 16, there are two parts in which Product A is adjacent to Product B. Therefore, the value of the component f_{AB} of the feature vector f_{A} of Product A, which is used as analysis data in the present exemplary embodiment, may be 2.

Using the analysis data including data sets each including the feature vector of Product A, which has been obtained in such a manner as described above, and the sales amount y_{A} of Product A, the analysis processor 102 may calculate θ_{A} satisfying Expression (4) below.

[Expression 4]

Minimize|y_{A}−Σθ_{Ax}f(A,x)| (4)

In Expression (4), x may indicate an adjacent product (x=A, B, C, . . . ).

The analysis processor 102 may perform data analysis using the analysis data. For example, the result of the data analysis θ_{A} may be θ_{A}=(700, 600, 300, 300, 50, . . . ) as illustrated in FIG. 17. Each component θ_{Ax} of θ_{A} may indicate a weight of the relevant adjacent product x adjacent to Product A. A component having a larger weight may indicate that the relevant adjacent product produces higher sales of Product A. Therefore, in the analysis result example illustrated in FIG. 17, the sales of Product A are the highest if Product A is placed adjacent to Product A. As described above, the data analysis apparatus 10 according to the present exemplary embodiment can specify, for each product name, connection between a product indicated by the product name and an adjacent product producing highest sales of the product.

As described above, the data analysis apparatus 10 according to the present exemplary embodiment may provide, for each product name, weights of adjacent products adjacent to a product indicated by the product name, as an analysis result. As described above, the data analysis apparatus 10 can output an analysis result with more consideration of connection between a positional relation between products and commodity exchange data for each product name. Therefore, the data analysis apparatus 10 according to the present exemplary embodiment can provide more useful information that can be used for providing optimum placement of products.

### Seventh Example

A seventh example of the present disclosure will be described with reference to the drawings.

The above sixth example has been described in terms of a method in which data analysis is performed without using information for respective shelves. In some instances, as in each of the first to fifth examples described above, the information for respective shelves may further be used.

The present exemplary embodiment will be described with sales amounts employed as commodity exchange data. In some instances, the commodity exchange data may include sales amounts or other information. The present exemplary embodiment will be described in terms of an example in which an analysis processor 102 performs data analysis using a least-squares method. In some instances, as with the analysis processor 102 in each of the above-described exemplary embodiments, another analysis method may be used.

A configuration of a data analysis system 1 and a functional configuration of a data analysis apparatus 10 in the data analysis system 1 in the present exemplary embodiment may be similar to those of the first example.

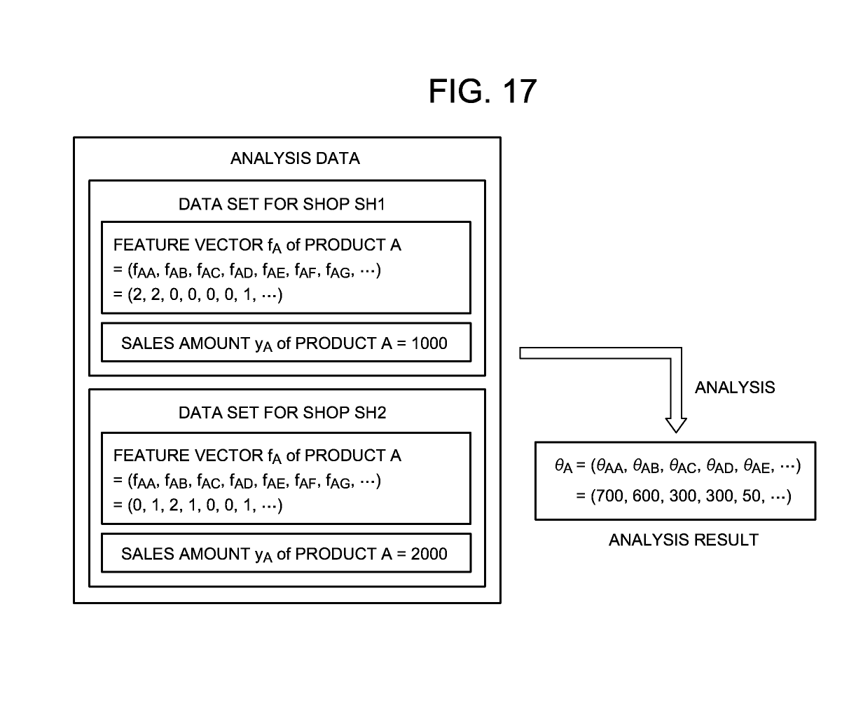

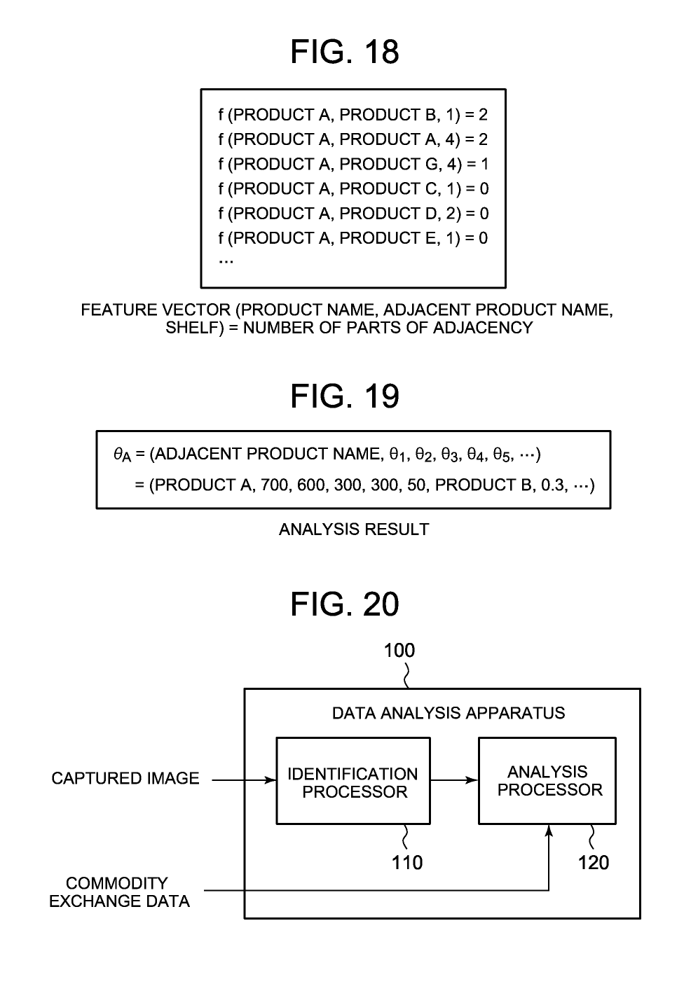

FIG. 18 is a diagram illustrating an example of respective elements of a feature vector used by the analysis processor 102 in the data analysis apparatus 10 according to at least one exemplary embodiment.

Using the identification result illustrated in FIG. 16, the analysis processor 102 in the data analysis apparatus 10 according to the present exemplary embodiment may convert the identification result into feature vectors f with a product name, an adjacent product name indicating an adjacent product adjacent to a product indicated by the product name, and a shelf on which the product is placed as variables (product name, adjacent product name, shelf). In this case, in the present exemplary embodiment, as illustrated in FIG. 18, each component of a feature vector f can be expressed by the number of parts of adjacency between a certain product and an adjacent product adjacent to the product on a certain shelf of a rack. For example, “f (product A, product B, 1)=1” may indicate that on a first shelf, there is one part in which a product whose product name is “Product A” is adjacent to an adjacent product whose adjacent product name is “Product B”.

The analysis processor 102 may perform data analysis on a shelf-by-shelf basis and a product name-by-product name basis. A method for the data analysis may be similar to each of the above-described exemplary embodiments. FIG. 19 is a diagram illustrating an example of a result of the analysis by the analysis processor 102 in the data analysis apparatus 10 according to at least one exemplary embodiment.

The analysis result illustrated in FIG. 19 may include, for each adjacent product name, the adjacent product name and weights of respective shelves for a product indicated by the adjacent product name as components of the analysis result. For example, the respective components of the analysis result following the product of the adjacent product name “Product A” may be a weight of a first shelf, a weight of a second shelf, . . . and a weight of a fifth shelf for a product adjacent to Product A.

As in the above-described second example, the analysis processor 102 may perform analysis on an adjacent product name-by-adjacent product name basis. In the analysis result in the present exemplary embodiment, a component having a larger weight may indicate a shelf producing higher sales of Product A in relation to an adjacent product. Therefore, in the analysis result example illustrated in FIG. 19, sales of Product A adjacent to a product whose product name is “Product A” may be the highest on the second shelf. As described above, the data analysis apparatus 10 according to the present exemplary embodiment can specify connection with an adjacent product producing highest sales, on a product name-by-product name basis and a shelf-by-shelf basis.

As described above, the data analysis apparatus 10 according to the present exemplary embodiment may provide, for each product name, weights of respective shelves for an adjacent product adjacent to a product indicated by the product name as an analysis result. As described above, the data analysis apparatus 10 can output an analysis result with more consideration of connection between a positional relation between the products and commodity exchange data, for each product name. Therefore, the data analysis apparatus 10 according to the present exemplary embodiment may enable provision of more useful information that can be used for providing optimum placement of products.

The analysis data in the above-describe first to seventh examples may arbitrarily be combined. In other words, for variables of a feature vector used by the analysis processor 102 in the data analysis apparatus 10, a combination of any of (1) to (6) below may be employed.

(1) Rack position information
(2) Product name
(3) Product category
(4) Product name of a product adjacent to at least any of the left, the right, the top and the bottom of a relevant product within a predetermined range
(5) Product category of a product adjacent to at least any of the left, the right, the top and the bottom of a relevant product within a predetermined range
(6) Sold-out information for a product adjacent to at least any of the left, the right, the top and the bottom of a relevant product within a predetermined range information In each of the above-described exemplary embodiments, data analysis may be performed using a captured image captured of one rack. In some instances, the method of data analysis may not be limited to this case. The data analysis apparatus 10 may perform data analysis using respective captured images captured of plural racks in a shop. In this case, the data analysis apparatus 10 may calculate weights of the racks in the entire shop.

Racks in a shop may have different numbers of shelves depending on placement positions thereof. The data analysis apparatus 10 may perform data analysis for each set of racks having a same number of shelves.

The adjacent product may be a product for a certain product, or adjacent products (adjacent product group) for a group of products of a certain type or a group of products having a certain product name.

Each of the above-described exemplary embodiments may be configured so that commodity exchange data further includes information that can be collected in each shop. For example, commodity exchange data may include, e.g., the population of a city in which the shop exists and/or the weather of the date on which the commodity exchange data was collected. The analysis processor 102 may perform data analysis in consideration of such information. The analysis processor 102 may perform data analysis using buying information for products.

Data analysis may be performed using, e.g., information indicating manufacturers of products, other than product names and product categories of the products.

Where a POP (point-of-purchase) advertisement or the like explaining a product identified by an imaging apparatus 20 is included within a predetermined range from the identified product, the imaging apparatus 20 may transmit an identification result provided with a flag indicating that the POP advertisement is provided, to the data analysis apparatus 10.

When the data analysis apparatus 10 performs data analysis using received captured image data and commodity exchange data, the data analysis apparatus 10 may perform the data analysis not only for products included in the captured image data but also for, e.g., POP advertisements and the like explaining the products. In other words, the data analysis apparatus 10 may analyze not only the products themselves, but also POP advertisements and the like explaining the products to analyze a relation with sales of the products explained by the POP advertisements.

For example, in a storage 103, not only product images, but also POP advertisement images may be stored. An identification processor 101 may identify a POP advertisement included in a captured image represented by the captured image data using the captured image and the POP advertisement images stored in the storage 103. The identification processor 101 may specify a position at which the identified POP advertisement is placed. The identification processor 101 may generate output data associating POP advertisement information indicating the identified POP advertisement and rack position information indicating the specified placement position of the POP advertisement with each other, and supply the output data to the analysis processor 102 as an identification result. The analysis processor 102 may analyze a relation between the placement position of the POP advertisement and sales of the product explained by the POP advertisement using the identification result and the commodity exchange data.

As described above, the data analysis apparatus 10 according to the present exemplary embodiment may analyze not only product themselves, but also POP advertisements and the like explaining the products to analyze a relation with sales of the products explained by the POP advertisements. Consequently, the data analysis apparatus 10 according to the present exemplary embodiment may enable measurement of, e.g., an effect of POP advertisements and/or effects relative to placement positions of the POP advertisements.

### Eighth Example

An eighth example of the present disclosure will be described. The present exemplary embodiment will be described in terms of a minimum configuration achievable the object of the present disclosure.

FIG. 20 is a diagram illustrating a functional configuration of a data analysis apparatus 100 according to at least one exemplary embodiment. As illustrated in FIG. 20, the data analysis apparatus 100 may include an identification processor 110 and an analysis processor 120.

The identification processor 110 may correspond to the identification processor 101 according to the above-described first to seventh examples. The identification processor 110 may identify products included in a captured image, using, for example, product images stored in a storage apparatus. The identification processor 110 may specify placement positions of the products.

The analysis processor 120 may correspond to the analysis processor 102 according to the above-described first to seventh examples. The analysis processor 120 may analyze connection between a positional relation among the products and sales of the products based on the specified placement position of the products and the commodity exchange data of the products.

On one shelf of a shop rack, one or more products of one or more types may be placed. A shop rack may accommodate plural products placed on the respective shelves as described above. On a shelf that produces highest sales, one or more products, sales of which are relatively high, may be often placed.

As described above, as a result of the analysis based on the specified placement positions of products and commodity exchange data of the products, the data analysis apparatus 100 can output an analysis result with, for example, connection between a positional relation among a product placed on a shelf and a product placed on another shelf, and sales of the products taken into consideration. The data analysis apparatus 100 can output an analysis result with, for example, a positional relation between products in which plural products, sales of which are relatively high, are placed, and sales of the products taken into consideration.

By outputting such analysis result, the data analysis apparatus 100 according to the present exemplary embodiment can provide more useful information that can be used for optimum placement of products.

### Ninth Example

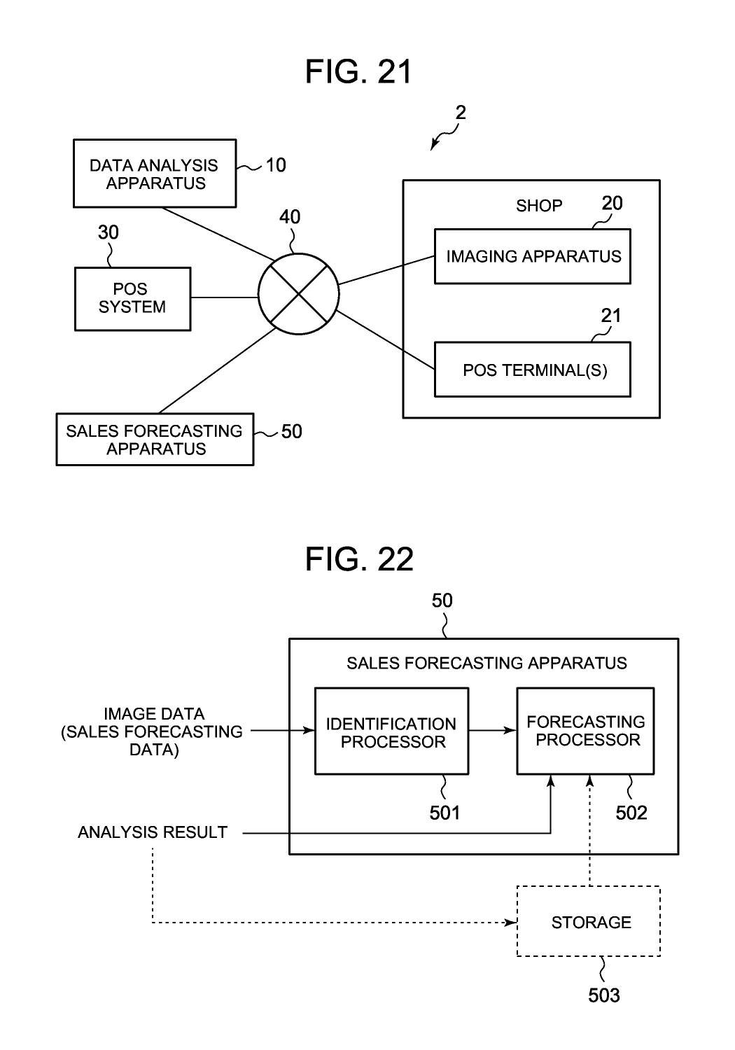

The present exemplary embodiment will be described in terms of a sales forecasting system to which a data analysis apparatus according to the respective exemplary embodiments described above has been applied. FIG. 21 is a diagram illustrating an example of an overall configuration of a sales forecasting system according to at least one exemplary embodiment. A sales forecasting system 2 according to the present exemplary embodiment may be configured in such a manner that a sales forecasting apparatus 50 is included in a data analysis system including a data analysis apparatus according to the above-described first to eighth examples. As illustrated in FIG. 21, the sales forecasting system 2 according to the present exemplary embodiment may include a data analysis apparatus 10, an imaging apparatus 20, POS terminal(s) 21, a POS system 30 and the sales forecasting apparatus 50. The data analysis apparatus 10, the imaging apparatus 20, the POS terminal(s) 21, the POS system 30 and the sales forecasting apparatus 50 are mutually connected via a network 40. The sales forecasting system 2 illustrated in FIG. 21 may be one indicating a configuration particular to the present disclosure, and the sales forecasting system 2 illustrated in FIG. 21 may include some members.

### (Sales Forecasting Apparatus 50)

FIG. 22 is a functional block diagram illustrating an example of a functional configuration of the sales forecasting apparatus 50 according to at least one exemplary embodiment. As illustrated in FIG. 22, the sales forecasting apparatus 50 may include an identification processor 501 and a forecasting processor 502. The sales forecasting apparatus 50 may be configured so as to further include a storage 503. Sales forecasting apparatus 50 may include a memory (not shown) storing instructions executable by one o more processors to carry out the disclosed operations.

In the storage 503, data that is similar to that in the above-described storage 103 may be stored. In the storage 503, analysis results of analysis by the data analysis apparatus (10, 100) according to the above-described first to eighth examples may be further stored.

As with the above-described identification processor 101, the identification processor 501 may identify products in a captured image represented by received captured image data, using the captured image and product images stored in the storage 503. The identification processor 501 may specify positions at which the identified products are placed. The identification processor 501 may supply a result of the identification to the forecasting processor 502.

The captured image data received by the identification processor 501 from the imaging apparatus 20 may be image data for sales forecasting. In order to distinguish between such image data and image data for data analysis, in the present exemplary embodiment, the captured image data received by the identification processor 501 may be referred to as sales forecasting data, and an image represented by the sale forecasting data may be referred to as a sales forecasting image.

The forecasting processor 502 may receive the output data (identification result) output by the identification processor 501, from the identification processor 501. The forecasting processor 502 may receive an analysis result output from the data analysis apparatus (10, 100) according to the above-described first to eighth examples. The forecasting processor 502 may obtain an analysis result stored in the storage 503 instead of the analysis result from the data analysis apparatus (10, 100) or in addition to the analysis result.

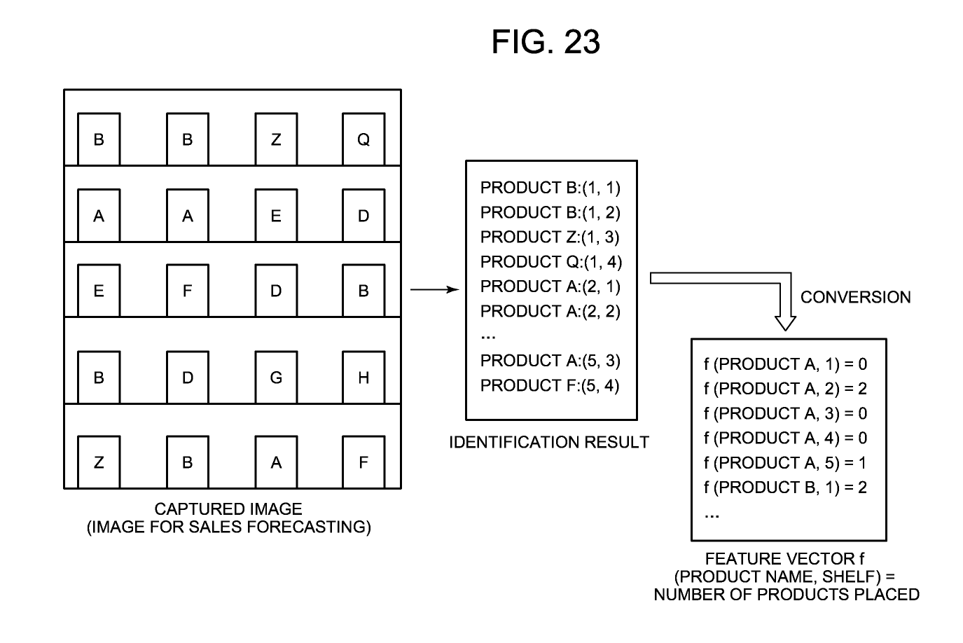

The forecasting processor 502 may perform sales forecasting for placement of products on shelves of a shop rack of which the sales forecasting image was captured, using the identification result and the analysis result. FIG. 23 is a diagram for describing operation of the forecasting processor 502 in the sales forecasting apparatus 50 according to at least one exemplary embodiment.

The present exemplary embodiment will be described assuming that the imaging apparatus 20 captures an image such as illustrated on the left side of FIG. 23. If the captured image (sales forecasting image) is an image such as illustrated on the left side of FIG. 23, the identification processor 501 may output an identification result such as illustrated approximately in a center of FIG. 23.

The forecasting processor 502 may convert the identification result into feature vectors f with a product name and a shelf of the shop rack as variables (product name, shelf). A method for conversion of the identification result to the feature vectors by the forecasting processor 502 may be similar to the method for conversion into feature vectors by the analysis processor 102 described above.

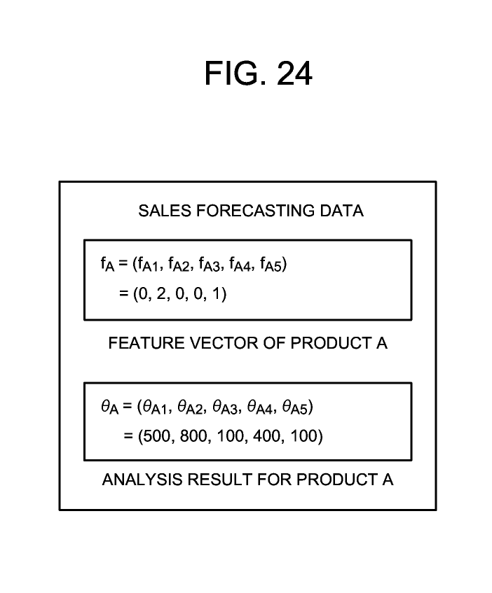

Using the feature vectors, the forecasting processor 502 may convert the feature vectors into data that enables sale forecasting. In the present exemplary embodiment, it is assumed that the sales forecasting apparatus 50 performs sales forecasting for a product whose product name is Product A. FIG. 24 is a diagram illustrating an example of sales forecasting data used for sales forecasting by the forecasting processor 502 in the sales forecasting apparatus 50 according to at least one exemplary embodiment.

As illustrated in FIG. 24, the forecasting processor 502 may use feature vectors for “Product A”, for which sales forecasting is performed, from among the feature vectors illustrated in FIG. 23, and a result of analysis of Product A, as sales forecasting data. The result of analysis of Product A may be one provided as a result of analysis by the data analysis apparatus 10 according to the above-described second example.

The forecasting processor 502 may forecast the sales using the sales forecasting data, according to Expression (5) below.

[Expression 5]

y_{A}=Σθ_{Ai}f_{Ai} (5)

In Expression (5), i may indicate a shelf of a rack (i=1, 2, 3, 4, 5). y_{A} may be a sales forecasting result. The sales forecasting result may be information indicating forecasted sales of products having a product name of Product A. The sales forecasted by the forecasting processor 502 may include sales amounts, sales volumes or other data. The forecasting processor 502 may use an analysis result suitable for information to be forecasted.

As described above, the sales forecasting apparatus 50 according to the present exemplary embodiment can forecast sales of a product, using an analysis result of analysis by the data analysis apparatus (10, 100) according to the above-described first to eighth examples. As described above, sales forecasting may be performed using more useful information, enabling provision of optimum placement of products in a more favorable manner.

Where the sales for the entire shop rack is forecasted, the sales forecasting apparatus 50 may forecast the sales of all the products using Expression (5) above and calculate a total of the sales to forecast the sales for the entire shop rack.

The sales forecasting apparatus 50 according to the present exemplary embodiment can perform sales forecasting for a product included in a sales forecasting image, for which no data analysis has been performed. As an example, a case where Product A, Product B, Product C and Product D are placed on a certain shelf of a shop rack, there is results of analysis of Product A, Product B and Product C, and there is no result of analysis of Product D will be described.

Where the sales forecasting apparatus 50 performs sales forecasting for Product D in this situation, the sales forecasting apparatus 50 may use an average of the results of analysis of Product A, Product B and Product C as a result of analysis of Product D. If a product category of Product D is the same as a product category of Product A, the sales forecasting apparatus 50 may use the result of analysis of Product A as a result of analysis of Product D.

As described above, the sales forecasting apparatus 50 may use results of analysis of products for which data analysis has been performed, for a product included in a sales forecasting image, for which no data analysis has been performed, enabling forecasting of sales of the product for which no data analysis has been performed.

### (Variation)

The above ninth example has been described in terms of a configuration in which the data analysis apparatus 10 and the sales forecasting apparatus 50 are separated from each other. In some instances, the configuration of the data analysis apparatus 10 and the sales forecasting apparatus 50 may not be limited to this configuration. The data analysis apparatus 10 and the sales forecasting apparatus 50 may be provided by a single apparatus.

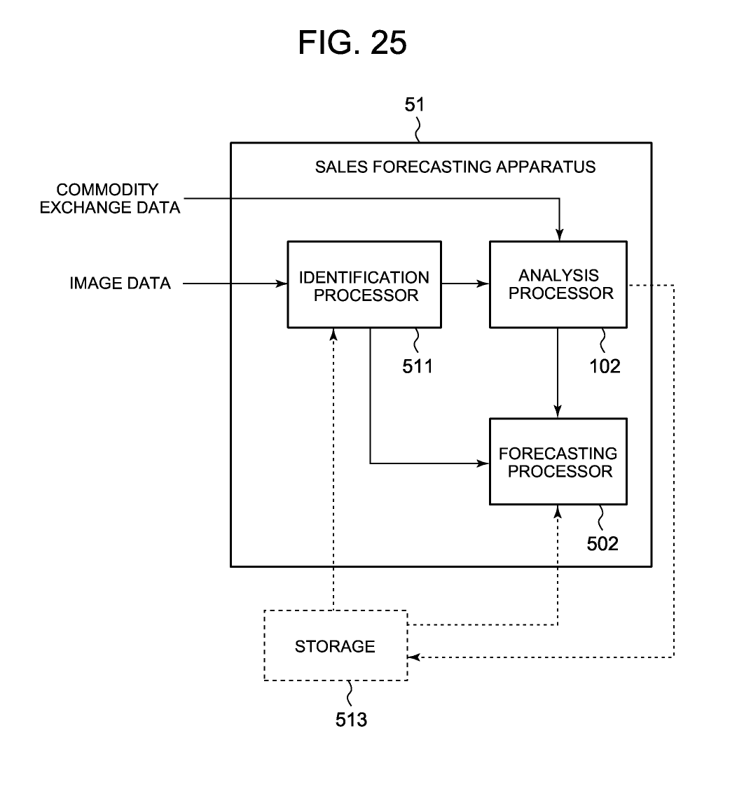

FIG. 25 is a diagram illustrating an example of a functional configuration of a sales forecasting apparatus 51 according to at least one exemplary embodiment. As illustrated in FIG. 25, the sales forecasting apparatus 51 according to the present variation may include an identification processor 511, an analysis processor 102 and a forecasting processor 502. The sales forecasting apparatus 51 may be configured so as to further include a storage 513.

The identification processor 511 may have functions of an identification processor 101 and an identification processor 501. If a received captured image data is image data for data analysis, the identification processor 511 may supply an identification result to an analysis processor 102. If a received captured image data is image data for sales forecasting, the identification processor 511 may supply an identification result to the forecasting processor 502. Information indicating whether captured image data is for data analysis or for sales forecasting may be provided by a user or may be included in the captured image data.

As with the analysis processor 102 according to the above-described first to eighth examples, the analysis processor 102 may perform data analysis. The analysis processor 102 may supply a result of the analysis to the forecasting processor 502. The analysis processor 102 may store the analysis result in the storage 513.

As with the forecasting processor 502 according to the above-described ninth example, the forecasting processor 502 may perform sales forecasting.

As described above, as with the sales forecasting apparatus 50 according to the above-described ninth example, the sales forecasting apparatus 51 according to the present exemplary embodiment can perform sales forecasting using more useful information.

### <Example Hardware Configuration>

An example hardware configuration that can provide a data analysis apparatus (10, 100) and a sales forecasting apparatus (50, 51) according to each of the above-described exemplary embodiments will be described. Each of the data analysis apparatus (10, 100) and the sales forecasting apparatus (50, 51) described above may be provided as a dedicated apparatus, but may be provided using a computer (information processing apparatus).

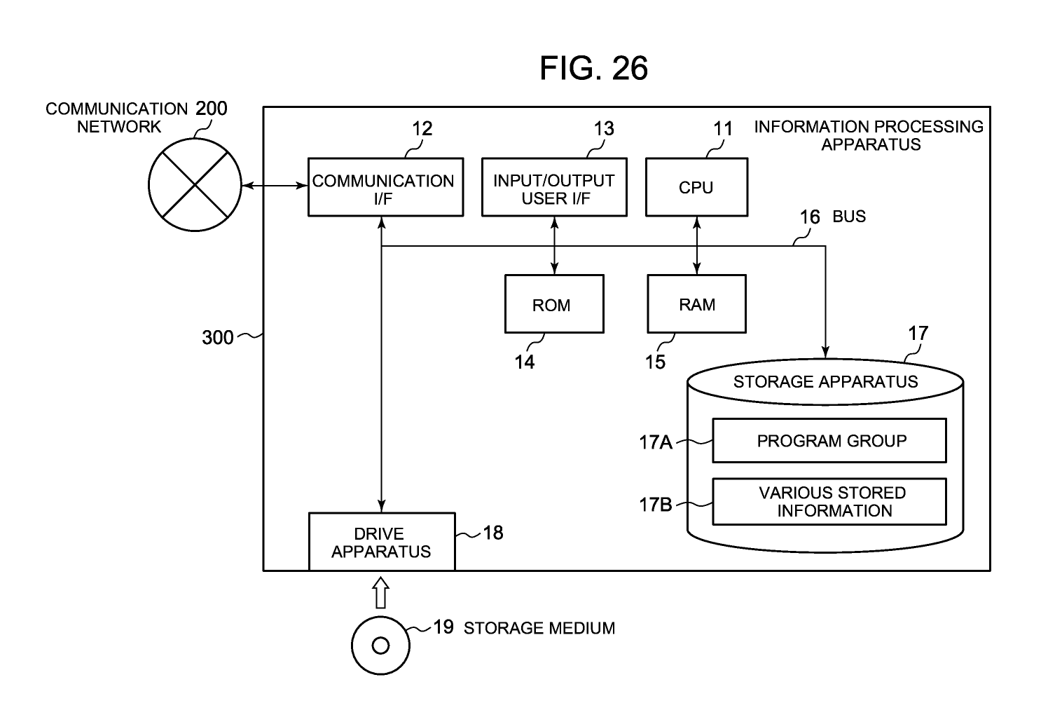

FIG. 26 is a diagram illustrating an exemplary hardware configuration of a computer (information processing apparatus) that can provide each exemplary embodiment of the present disclosure.

Hardware of the information processing apparatus (computer) 300 illustrated in FIG. 26 may include a CPU (central processing unit) 11, a communication interface (I/F) 12, an input/output user interface 13, a ROM (read-only memory) 14, a RAM (random access memory) 15, a storage apparatus 17 and a drive apparatus 18 for a computer-readable storage medium 19, which are interconnected via a bus 16. The input/output user interface 13 may be a man-machine interface such a keyboard, which is an example of an input device, and/or a display, which is an output device. The communication interface 12 may be a common communication channel for the apparatus according to each of the above-described exemplary embodiments (FIGS. 2, 8, 20, 22 and 25) to communicate with an external apparatus via a communication network 200. In such hardware configuration, the CPU 11 may control operation of the entire information processing apparatus 300 that provides the data analysis apparatus (10, 100) and the sales forecasting apparatus (50, 51) according to each exemplary embodiment.

The present disclosure described taking the above exemplary embodiments as examples may be achieved by, for example, supplying programs (computer programs) that can provide the processing described in the above respective exemplary embodiments to the information processing apparatus 300 illustrated in FIG. 26, and then the programs may be read out to the CPU 11. Such programs may be programs that can provide various processing described in the above respective exemplary embodiments or the respective processors (respective blocks) indicated in the relevant apparatuses in the block diagrams illustrated in FIGS. 2, 8, 20, 22 and 25.

The programs supplied in the information processing apparatus 300 may be stored in a readable/writable temporary memory (15) or a non-volatile storage apparatus (17) such as a hard disk drive. For example, a program group 17A in the storage apparatus 17 may include programs that can provide functions of the respective processors illustrated in the data analysis apparatus (10, 100) and the sales forecasting apparatus (50, 51) according to the respective exemplary embodiments described above. Examples of various stored information 17B may include, e.g., the identification results, the commodity exchange data, the analysis results and/or the forecasted sales in the respective exemplary embodiments described above. In implementation of the programs to the information processing apparatus 300, units of individual program modules may not be limited to the respective blocks illustrated in the block diagrams (FIGS. 2, 8, 20, 22 and 25), and a person skilled in the art may arbitrarily select such units of program modules in the implementation.

In the above case, as a method of supplying the programs to the apparatus, any of currently-common procedures such as the method of installing the programs into the apparatus via any of various computer-readable recording mediums (19) such as a CD (compact disk)-ROM and a flash memory and the method of downloading the programs externally via a communication channel (200) such as the Internet can be employed. In such case, the present disclosure can be regarded as being provided by codes included in the computer programs (program group 17A), or the storage medium (19) with the codes stored thereon.

The present disclosure has been described in terms of examples in which the present disclosure is applied to the above exemplary embodiments and examples thereof. However, the technical scope of the present disclosure may not be limited to the scope described in the respective exemplary embodiments and examples described above. It is clear to a person skilled in the art that various variations or improvements of the exemplary embodiments are possible. In such case, different exemplary embodiments resulting from the variations or improvements also fall within the technical scope of the present disclosure.

1. A data analysis apparatus comprising:
a memory storing instructions; and
at least one processor configured to process the instructions to:
identify products included in a captured digital image based on digitally processing the captured digital image,
specify coordinates indicating placement positions of the products, and
analyze a connection between a positional relation among the products and sales of the products based on the placement positions of the products and commodity exchange data of the products.

2. The data analysis apparatus according to claim 1,
wherein each of the placement positions of the products includes a position of a shelf in a shop rack on which the product is placed; and
wherein the at least one processor is further configured to process the instructions to:
analyze the connection based on the positions of the shelves in the shop rack on which the plurality of products are placed respectively, and the commodity exchange data of the products.

3. The data analysis apparatus according to claim 1, wherein the at least one processor is further configured to process the instructions to:
analyze the connection for each product name.

4. The data analysis apparatus according to claim 1, wherein the at least one processor is further configured to process the instructions to:
analyze the connection for each product category.

5. The data analysis apparatus according to claim 1, wherein the at least one processor is further configured to process the instructions to:
analyze the connection between the positional relation among the product and the sales of the product based on the placement position of the product, the commodity exchange data of the product, and adjacent products adjacent to the product.

6. The data analysis apparatus according to claim 5, wherein the at least one processor is further configured to process the instructions to:
analyze the connection for each of adjacent product names indicating the adjacent products.

7. The data analysis apparatus according to claim 5, wherein the at least one processor is further configured to process the instructions to:
analyze the connection for each of product categories of the adjacent products.

8. The data analysis apparatus according to claim 5, wherein the at least one processor is further configured to process the instructions to:
analyze the connection based on sold-out information for any of the adjacent products.

9. The data analysis apparatus according to claim 5, wherein each of the adjacent products is a product adjacent to at least one of a right and a left of the relevant identified product.

10. The data analysis apparatus according to claim 5, wherein each of the adjacent products is a product adjacent to at least one of a top or a bottom of the relevant identified product.

11. The data analysis apparatus according to claim 5, wherein each of the adjacent products is a product adjacent to the relevant identified product within a predetermined range.

12. A data analysis system comprising:
an imaging apparatus that captures an image of a shop rack;
a POS (point-of-sale) system that manages commodity exchange data for a shop in which the shop rack is placed; and
a data analysis apparatus comprising:
a memory storing instructions; and
at least one processor configured to process the instructions to:
identify products included in a captured digital image based on digitally processing the captured digital image,
specify coordinates indicating placement positions of the products, and
analyze connection between a positional relation among the products and sales of the products based on the placement positions of the products and commodity exchange data of the products
wherein the data analysis apparatus uses the image of the shop rack for identifying the products; and
wherein the data analysis apparatus uses the commodity exchange data for analyzing the connection between the positional relation among the products and sales of the products based on the placement positions of the products and the commodity exchange data of the product.

13. The data analysis apparatus according to claim 1, wherein the at least one processor is further configured to process the instructions to:
identify another product included in another captured image, and
perform sales forecasting for the another product using a result of the identification and a result of the analysis.

14. The data analysis apparatus according to claim 1, wherein at least one processor is further configured to process the instructions to:
identify other products included in other captured images, and
perform sales forecasting for the other products included in the other captured images using a result of the analysis and a result of identification for the other captured images.

15. The data analysis system according to claim 12, further comprising:
a sales forecasting apparatus that includes:
a memory storing instructions; and
at least one processor configured to process the instructions to:
identify other products included in other captured digital images captured by the capturing device based on digitally processing the other captured digital images, and
perform sales forecasting for the other products included in the other captured images, using a result of the analysis and a result of the identification for the other captured images.

16. A data analysis method comprising:
identifying products included in a captured digital image based on digitally processing the captured digital image using at least one computer processor;
specifying coordinates indicating placement positions of the products; and
analyzing connection between a positional relation among the products and sales of the products based on the placement positions of the products and commodity exchange data of the products.

17. The data analysis method according to claim 16, further comprising:
capturing an image of a shop rack;
managing commodity exchange data for a shop in which the shop rack is placed;
using the image of the shop rack for identifying the products; and
using the commodity exchange data for analyzing the connection between the positional relation among the products and sales of the products based on the placement positions of the products and the commodity exchange data of the product.

18. The data analysis method according to claim 16, further comprising:
identifying another product included in another captured image; and
performing sales forecasting for the another product using a result of the identification and a result of the analysis.

19. The data analysis method according to claim 16, further comprising:
identifying other products included in other captured image; and
performing sales forecasting for the other products included in the other captured image using a result of the analysis and a result of identification for the other captured image.

20. The data analysis method according to claim 17 comprising:
identifying other products included in other captured images; and
performing sales forecasting for the other products included in the other captured images, using a result of the analysis and a result of the identification for the other captured images.

21. A non-transitory computer-readable storage medium storing instructions that, when executed by a computer, enable the computer to implement a method comprising:
identifying products included in a captured digital image based on digitally processing the captured digital image;
specifying coordinates indicating placement positions of the products; and
analyzing connection between a positional relation among the products and sales of the products based on the placement positions of the products and commodity exchange data of the products.

22. The non-transitory computer-readable storage medium according to claim 21, wherein the method further comprises:
identifying other products included in other captured image; and
performing sales forecasting for the other products included in the other captured image using a result of the analysis and a result of identification for the other captured image.
